(19) United States
(12) Patent Application Publication
(10) Pub. No.: US 2021/0350788 A1
(43) Pub. Date: Nov. 11, 2021

(54) ELECTRONIC DEVICE FOR GENERATING SPEECH SIGNAL CORRESPONDING TO AT LEAST ONE TEXT AND OPERATING METHOD OF THE ELECTRONIC DEVICE

(71) Applicant: Samsung Electronics Co., Ltd., Suwon-si (KR)

(72) Inventors: Kihyun CHOO, Suwon-si (KR); Sangjun PARK, Suwon-si (KR); Nicholas LANE, Staines (GB); Ravichander VIPPERLA, Staines (GB); Sourav BHATTACHARYA, Staines (GB); Syed Samin ISHTIAQ, Staines (GB); Taehwa KANG, Suwon-si (KR); Jonghoon JEONG, Suwon-si (KR)

(21) Appl. No.: 17/198,727

(22) Filed: Mar. 11, 2021

Related U.S. Application Data
(60) Provisional application No. 63/020,712, filed on May 6, 2020.

(30) Foreign Application Priority Data
Aug. 11, 2020 (KR) 10-2020-0100676

(51) Int. Cl. G10L 13/08; G10L 13/02

(52) U.S. Cl. CPC G10L 13/08; G10L 13/02

(57) ABSTRACT

A method, performed by an electronic device, of generating a speech signal corresponding to at least one text is provided. The method includes obtaining feature information with respect to a first sample included in the speech signal, based on the at least one text, obtaining condition information related to a condition under which a bunching operation, in which one or more sample values included in the speech signal are obtained, is performed, based on the feature information, configuring one or more bunching blocks for performing the bunching operation, based on the condition information, obtaining the one or more sample values based on the feature information with respect to the first sample by using the one or more bunching blocks, and generating the speech signal based on the obtained one or more sample values.

### CROSS-REFERENCE TO RELATED APPLICATION(S)

This application is based on and claims priority under 35 U.S.C. § 119(e) of a U.S. Provisional application Ser. No. 63/020,712, filed on May 6, 2020, in the U.S. Patent and Trademark Office, and under 35 U.S.C. § 119(a) of a Korean patent application number 10-2020-0100676, filed on Aug. 11, 2020, in the Korean Intellectual Property Office, the disclosure of which is incorporated by reference herein in its entirety.

### BACKGROUND

### 1. Field

The disclosure relates to an electronic device for generating a speech signal corresponding to at least one text and an operating method of the electronic device.

### 2. Description of Related Art

A speech synthesis technique, also called text-to-speech (TTS), is a technique that is used to reproduce a speech corresponding to entered text utterances, without a pre-recorded actual voice of a human being. According to neural speech synthesis, feature information of a speech corresponding to a text may be estimated by an acoustic model, and the estimated feature information of the speech may be processed by a neural vocoder to extract a speech signal corresponding to the text.

According to the speech synthesis technique using the neural vocoder, feature information about a speech signal in a frame unit or a sample unit corresponding to a temporal section of each speech signal may be obtained according to the feature information of the speech corresponding to the text. However, an auto-regressive (AR)-based neural vocoder outputs a current value by receiving a previously output value as an input value. Accordingly, because values are sequentially obtained, the amount of operations may be increased, and it may take longer to obtain a final result.

Therefore, a method capable of minimizing deterioration of sound quality of a speech signal and optimizing the amount of operations of a neural vocoder is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for generating a speech signal corresponding to at least one text and an operating method of the electronic device.

Another aspect of the disclosure is to provide a computer-readable recording medium having recorded thereon a program for executing the operating method on a computer. Technical objectives of the disclosure are not limited to the objectives described above and may include other technical objectives.

Additional aspects will be set forth in part in the description which follows and, in part, will be apparent from the description, or may be learned by practice of the presented embodiments.

In accordance with an aspect of the disclosure, a method, performed by an electronic device, of generating a speech signal corresponding to at least one text is provided. The method includes obtaining feature information with respect to a first sample included in the speech signal, based on the at least one text, obtaining condition information related to a condition under which a bunching operation, in which one or more sample values included in the speech signal are obtained, is performed, based on the feature information, configuring one or more bunching blocks for performing the bunching operation, based on the condition information, obtaining the one or more sample values based on the feature information with respect to the first sample by using the one or more bunching blocks, and generating the speech signal based on the obtained one or more sample values.

In accordance with another aspect of the disclosure, an electronic device for generating a speech signal corresponding to at least one text is provided. The electronic device includes at least one processor configured to obtain feature information with respect to a first sample included in the speech signal, based on the at least one text, obtain condition information related to a condition under which a bunching operation, in which one or more sample values included in the speech signal are obtained, is performed, based on the feature information, configure one or more bunching blocks for performing the bunching operation, based on the condition information, obtain the one or more sample values based on the feature information with respect to the first sample by using the one or more bunching blocks, and generate the speech signal based on the obtained one or more sample values, and an output device configured to output the speech signal.

In accordance with another aspect of the disclosure, at least one non-transitory computer-readable recording medium may have recorded thereon a program for causing the electronic device to perform a method of generating the speech signal corresponding to the at least one text.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a speech signal corresponding to a text being generated according to an embodiment of the disclosure;

FIG. 2 is a block diagram illustrating a speech signal corresponding to a text being obtained based on a linear prediction value according to an embodiment of the disclosure;

FIG. 3 is a block diagram illustrating a bunching block group according to an embodiment of the disclosure;

FIG. 4 is a block diagram illustrating a bunching block according to an embodiment of the disclosure;

FIG. 5 is a block diagram illustrating an inner structure of an electronic device according to an embodiment of the disclosure;

FIG. 6 is a block diagram illustrating an inner structure of an electronic device according to an embodiment of the disclosure;

FIG. 7 is a flowchart of a method of generating a speech signal corresponding to a text according to an embodiment of the disclosure;

FIG. 8 is a block diagram illustrating parameter information being determined according to an embodiment of the disclosure; and

FIG. 9 is a block diagram illustrating a bunching operation being performed based on parameter information according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, when a part is referred to as being “connected” to other parts, the part may be “directly connected” to the other parts or may be “electrically connected” to the other parts with other devices therebetween. When a part “includes” a certain element, unless it is specifically mentioned otherwise, the part may further include another component and may not exclude the other component.

Functions related to artificial intelligence (AI) according to the disclosure are performed by a processor and a memory. The processor may include one or more processors. Here, the one or more processors may include a general-purpose processor, such as a central processing unit (CPU), an application processor (AP), and a digital signal processor (DSP), a graphics exclusive processor, such as a graphics processing unit (GPU) and a vision processing unit (VPU), or an AI exclusive processor, such as a neural processing unit (NPU). The one or more processors may control input data to be processed according to a predefined operation principle or an AI model stored in the memory. Alternatively, when the one or more processors are AI exclusive processors, the AI exclusive processors may be designed as hardware structures specialized for processing specific AI models.

The predefined operation principle or the AI model may be formed via learning. Here, the formation of the predefined operation principle or the AI model via the learning denotes that a basic AI model is trained by using a plurality of pieces of training data based on a learning algorithm, to form the predefined operation principle or the AI model configured to perform a desired feature (or purpose). This learning operation may be directly performed by a device configured to execute the AI function according to the disclosure or may be performed by an additional server and/or an additional system. Examples of the learning algorithm may include, but are not limited to, supervised learning, unsupervised learning, semi-supervised learning, or reinforcement learning.

The AI model may be formed of a plurality of neural network layers. Each of the plurality of neural network layers may have a plurality of weight values, and a neural network calculation may be performed through a calculation between a calculation result of a previous layer and the plurality of weight values. The plurality of weight values of the plurality of neural network layers may be optimized based on learning results of the AI learning model. For example, the plurality of weight values may be modified and refined to reduce or minimize the loss value or the cost value obtained by the AI learning model during a learning process. An artificial neural network may include a deep neural network (DNN). For example, the artificial neural network may include, but is not limited to, a convolutional neural network (CNN), the DNN, a recurrent neural network (RNN), a restricted Boltzmann machine (RMB), a deep belief network (DBN), a bidirectional recurrent deep neural network (BRDNN), or a deep Q-network.

Throughout the disclosure, the expression “at least one of a, b or c” indicates only a, only b, only c, both a and b, both a and c, both b and c, all of a, b, and c, or variations thereof.

Hereinafter, the disclosure will be described by referring to the accompanying drawings.

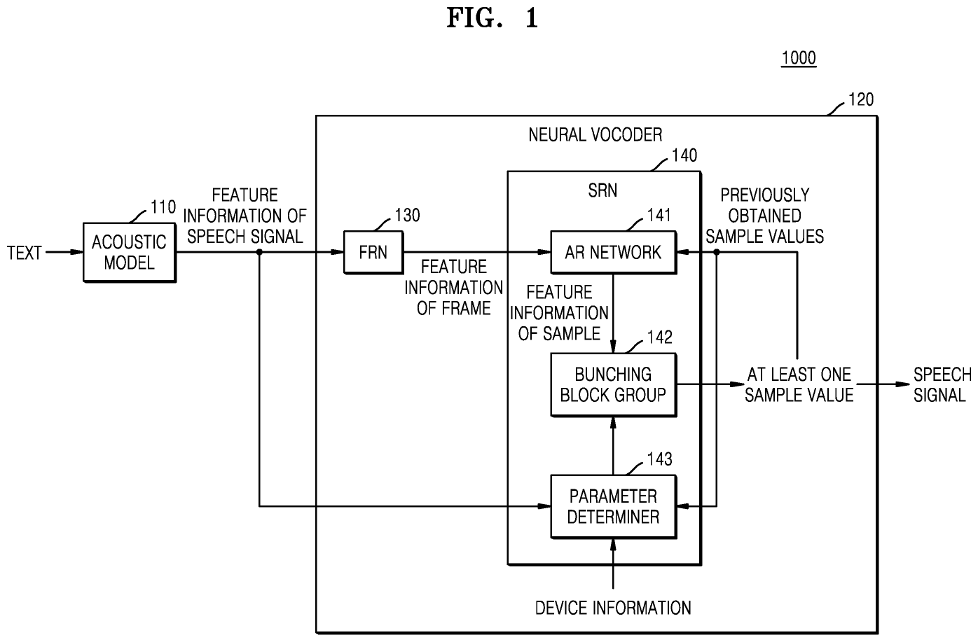

FIG. 1 is a block diagram illustrating a speech signal corresponding to a text being generated according to an embodiment of the disclosure.

Referring to FIG. 1, an electronic device 1000 according to an embodiment may generate a speech signal corresponding to at least one text by using an acoustic model 110 and a neural vocoder 120.

The electronic device 1000 according to an embodiment may be a device for generating a speech signal corresponding to a text and may be realized in various types. For example, the electronic device 1000 described in this specification may include a digital camera, a smartphone, a laptop computer, a tablet personal computer (PC), an electronic book terminal, a digital broadcasting terminal, a personal digital assistant (PDA), a portable multimedia player (PMP), a navigation device, a moving picture experts group phase 1 or phase 2 (MPEG-1 or MPEG-2) audio layer 3 (MP3) player, or a vehicle. However, the electronic device 1000 is not limited thereto. The electronic device 1000 described in this specification may be a wearable device which a user may wear. The wearable device may include at least one of an accessory-type device (e.g., a watch, a ring, a wrist band, an ankle band, a necklace, glasses, or contact lenses), a head-mounted-device (HMD), a fabric or clothing-integrated device (e.g., electronic clothing), a body-attached device (e.g., a skin pad), or a bio-implant device (e.g., an implantable circuit), but is not limited thereto.

The electronic device 1000 according to an embodiment may obtain feature information of a speech signal corresponding to at least one text in a predetermined time unit (e.g., a frame) by using the acoustic model 110. The acoustic model 110 according to an embodiment may be a model configured to extract a speech feature from a text. For example, tacotron may be used as the acoustic model 110. However, the acoustic model 110 is not limited thereto. Various types of models configured to extract, from a text, feature information of a speech signal corresponding to the text may be used as the acoustic model 110.

The acoustic model 110 according to an embodiment may extract the feature information of the speech signal by taking into account not only the text, but also style information of the speech signal. For example, the style information relates to information about a style of a speech and may include various information about styles of a speech signal, such as an emotional state (e.g., anger, happiness, or calmness) or an utterance style (e.g., an announcer, a child, a female, or a male). The disclosure is not limited to the example described above. The acoustic model 110 may extract the feature information of the speech signal not only based on the style information, but also based on various information related to the speech.

The acoustic model 110 according to an embodiment may include an encoder configured to generate feature information of a text from an input text, a decoder configured to predict feature information of a speech from the feature information of the text, and an attention configured to connect the encoder to the decoder. The disclosure is not limited to the example described above. The acoustic model 110 may include various components configured to extract, from a text, feature information of a speech signal corresponding to the text.

The feature information of the speech signal that is extracted by the acoustic model 110 according to an embodiment may include information indicating a feature of a speech signal in a predetermined unit (e.g., a frame unit) based on various methods, such as spectrogram or cepstrum. In addition, the feature information of the speech signal is not limited to the example described above and may be various information indicating a feature of a speech, such as information about a pitch lag, information about a pitch correlation, and information about an aperiodicity.

The feature information of the speech signal (e.g., a spectrogram, a cepstrum, information about a pitch lag, and information about a pitch correlation) that is extracted by the acoustic model 110 according to an embodiment may be input to the neural vocoder 120, to extract a speech signal which may be directly output via a speaker.

The speech signal according to an embodiment may be recognized by a human being only when the speech signal is output as sequential signals. Thus, the feature information of the speech signal that is output by the acoustic model 110 may be output in a predetermined unit, for example, a frame unit.

A frame of the speech signal according to an embodiment may be configured, for example, in a size of about 10 ms or about 12.5 ms, but is not limited thereto and may be configured in various sizes. For example, in the case of a frame having a length of about 10 ms, the number of samples 240 corresponding to one frame may be 240, based on a sampling rate of about 24 kHz (the number of sample values included in one second). Thus, the feature information of the speech signal that is generated by the acoustic model 110 may include feature information of 240 sample values per frame having a length of about 10 ms. The feature information of the speech signal according to an embodiment may be input to the neural vocoder 120, to obtain sample values included in the speech signal.

According to an embodiment of the disclosure, the feature information of the speech signal that is generated by the acoustic model 110 may be obtained per predetermined frame units. For example, the feature information of the speech signal may be output in a unit of R frames. Thus, in the case of a sampling rate of about 24 kHz, a frame length of about 10 ms, and R corresponding to 4, the feature information of the speech signal that corresponds to 960 (4*240) sample values may be generated.

The acoustic model 110 according to an embodiment may include at least one pre-trained AI model (e.g., a convolution layer, a fully connected (FC) layer, or the like). Thus, the feature information of the speech signal that is output from the acoustic model 110 may include hidden representation. The feature information of the speech signal is not limited thereto and may include various types of information indicating a feature of a speech signal.

The feature information of the speech signal that is extracted by the acoustic model 110 according to an embodiment may include information indicating a feature of a sample unit or a unit that is larger than the sample unit (e.g., a frame unit), rather than indicating a value of the sample unit. Thus, the feature information of the speech signal may include information that may not be directly output via a speaker. Thus, according to an embodiment of the disclosure, based on the feature information of the speech signal that is obtained by the acoustic model 110, the neural vocoder 120 may obtain the speech signal in a unit to be directly output via the speaker.

For example, the feature information of the speech signal in a frame unit, which is input to the neural vocoder 120, may be processed by an AI model (e.g., a convolution layer, an FC layer, or the like). Thereafter, from the feature information in the frame unit, feature information in a sample unit with respect to samples included in each frame may be obtained, and based on the feature information in the sample unit, the speech signal including values of the sample units may be finally obtained.

A sample value of the speech signal according to an embodiment may indicate a value corresponding to a section into which the speech signal is divided, so as to indicate the speech signal that is sequentially connected. For example, the sample value may include a value indicating a volume and a sign of the speech signal for each section of about 1/16000 seconds. Thus, according to an embodiment of the disclosure, the speech signal may be output via the speaker, according to the sample values included in the speech signal.

The neural vocoder 120 according to an embodiment may obtain the values in the sample units included in the speech signal, through a frame rate network (FRN) 130 and a sample rate network (SRN) 140, based on the feature information of the speech signal that is obtained by the acoustic model 110. The neural vocoder 120 according to an embodiment may finally obtain the speech signal based on values of various units, rather than being limited to the values in the frame units or the sample units described above.

The FRN 130 according to an embodiment may process the feature information of the speech signal that is input to the FRN 130, by using a pre-trained AI model (e.g., a convolution layer, an FC layer, or the like). The FRN 130 according to an embodiment may use various types of pre-trained AI models, in order to output the feature information of the speech signal in a frame unit by processing the feature information of the speech signal.

As a result of the operation performed by the AI model, the FRN 130 according to an embodiment may output the feature information of the speech signal in the frame unit by converting the feature information of the speech signal in the frame unit into a form that is to be input and processed by the SRN 140. The feature information of the speech signal in the frame unit, according to an embodiment of the disclosure, may be used by the SRN 140 to generate at least one sample value included in the corresponding frame.

The FRN 130 according to an embodiment may generate feature information with respect to a current frame by taking into account feature information of a peripheral frame adjacent to the current frame. Thus, feature information of a frame that is output by the FRN 130 may reflect feature information of a peripheral frame.

According to an embodiment of the disclosure, as a result of a process in which the FRN 130 processes the feature information of the speech signal in the frame unit that is output by the acoustic model 110, by using the AI model, feature information in the frame unit, which is in a vector format, may be output. Thus, the FRN 130 may convert the feature information of the speech signal into a data format, which may be processed by the SRN 140.

For example, the FRN 130 may output vector information in the frame unit, which has a size of 1×128. The disclosure is not limited thereto. The feature information of the speech signal that is output by the FRN 130 may include information in various units and formats, which may be input and processed by the SRN 140.

The feature information in the frame unit having the vector format according to an embodiment may be additionally processed to correspond to sample values and may be used to generate the sample values included in the same frame. According to an embodiment of the disclosure, when 240 samples are included in one frame, a vector value having a size of 240×128 may be obtained based on a vector value having a size of 1×128 via an upsampling operation, in order to reflect features of sample values changed in the same frame. Thus, the SRN 140 may generate the sample values included in the same frame, based on a value corresponding to each sample from among values included in the vector value having the size of 240×128.

The FRN 130 according to an embodiment may not only generate the feature information in the frame unit, but also may generate the feature information in a unit of R frames. For example, when the feature information in the unit of R frames is input by the acoustic model 110 into the FRN 130, the FRN 130 may generate the feature information in the unit of R frames, which is in a form to be input to the SRN 140, based on the feature information in the unit of R frames. In addition, the SRN 140 may generate sample values included in the R frames based on the feature information with respect to the R frames. The disclosure is not limited thereto. The FRN 130 may generate and output the feature information in various units.

The SRN 140 according to an embodiment may obtain feature information in a sample unit with respect to a current sample, based on the feature information in the frame unit that is output by the FRN 130. Then, via a bunching operation, the SRN 140 may obtain sample values from the feature information in the sample unit as a final speech signal.

According to an embodiment of the disclosure, the SRN 140 may obtain the feature information in the sample unit based on a sample value that is previously obtained, so that a current sample value may be obtained by taking into account the previously obtained sample value. In addition, the SRN 140 may obtain the current sample value based on the feature information in the frame unit with respect to a current sample. According to an embodiment of the disclosure, in addition to the current sample value, at least one sample value of a next order adjacent to the current sample value may be obtained based on the feature information with respect to the current sample. According to an embodiment of the disclosure, while one or more sample values may be obtained based on the feature information of samples respectively corresponding to the sample values, other sample values may be obtained based on the feature information of a previous sample.

Thus, according to an embodiment of the disclosure, without a need to obtain the feature information with respect to all of the samples, only the feature information with respect to one or more samples which are used for the bunching operation may be obtained. Accordingly, the amount of operations may be reduced in an operation of obtaining the feature information with respect to the samples. However, just as the amount of operations is reduced, the sound quality may be reduced, because the sample values are obtained based on the feature information with respect to other samples. Thus, the bunching operation may be performed to obtain the sample values having an appropriate amount of operations and an appropriate sound quality, based on information about a condition in which each sample value is obtained.

In addition, the SRN 140 according to an embodiment may obtain each sample value based on the feature information corresponding to each sample, which is generated by additionally processing the feature information in the frame unit. For example, the SRN 140 may obtain each sample value based on the vector value having the size of 240×128, which is obtained via the upsampling operation. According to an embodiment of the disclosure, when 240 samples are included in one frame, a vector value having a size of 240×128 may be obtained based on a vector value having a size of 1×128 via an upsampling operation, in order to reflect features of sample values changed in the same frame.

However, according to an embodiment of the disclosure, the vector value may be obtained according to the number of pieces of feature information in a sample unit that are output by an auto-regressive (AR) network 141 with respect to one frame. For example, when two sample values are obtained based on one piece of feature information in the sample unit via a sample bunching operation, and when the AR network 141 outputs 120 pieces of feature information in the sample unit with respect to one frame including 240 samples, the FRN 130 may output the vector value having the size of 120×128.

In addition, via the upsampling operation, the FRN 130 according to an embodiment may obtain a vector value (e.g., the vector value of the size of 120×128) corresponding to the number (e.g., 120) of pieces of feature information in the sample unit that are obtained by the AR network 141 with respect to one frame. The FRN 130 according to an embodiment may perform the upsampling operation by determining the number of pieces of feature information of the sample unit that are obtained by the AR network 141 with respect to one frame, based on a device-based parameter or a frame-based parameter.

In addition, while the feature information in the sample unit that is output from the AR network 141 corresponds to one sample, the feature information in the sample unit may include not only a feature of the corresponding sample, but also features of a plurality of samples. For example, the feature information in the sample unit with respect to one sample may be used to obtain a plurality of sample values according to the sample bunching operation, and thus, the feature information in the sample unit with respect to one sample may be generated to also include features of a plurality of samples. According to an embodiment of the disclosure, at least one AI model that is used by the AR network 141 to obtain the feature information in the sample unit may be pre-trained to generate the feature information in the sample unit, which also includes the features of the plurality of samples. Here, the upsampling operation according to an embodiment of the disclosure may be performed such that a value corresponding to one sample from among the vector value of the size of 120×128 may also include the features of the plurality of samples (e.g., two samples). Thus, based on the vector value of the size of 120×128, the AR network 141 may output the feature information in the sample unit corresponding to one sample, which may also include the features of the plurality of samples (e.g., two samples).

The bunching operation according to an embodiment may be an operation configured to obtain the sample values from the feature information in the sample unit. The bunching operation may include a sample bunching operation and a bit bunching operation. According to the sample bunching operation according to an embodiment of the disclosure, a plurality of sample values may be obtained from feature information with respect to one sample. In addition, according to the bit bunching operation, when the sample value is obtained from the feature information with respect to the sample, bits each indicating the sample value may be divided into a plurality of groups and then may be obtained and combined according to each group, so that the sample value may be obtained.

The SRN 140 according to an embodiment may include the AR network 141, a bunching block group 142, and a parameter determiner 143 configured to form a bunching block.

The AR network 141 according to an embodiment may obtain the feature information in the sample unit from the feature information in the frame unit. For example, the AR network 141 may obtain vector information in a sample unit with respect to a plurality of samples included in a corresponding frame, from vector information in a frame unit.

The AR network 141 according to an embodiment may output the feature information in the sample unit in a vector format, the same as the vector information in the frame unit that is output by the FRN 140.

The AR network 141 according to an embodiment may obtain the feature information in the sample unit with respect to a current sample by receiving at least one previously obtained sample value, in addition to the feature information in the frame unit, so that the bunching block group 142 may obtain a current sample value by taking into account the previously obtained sample value.

In addition, the AR network 141 according to an embodiment may obtain the feature information with respect to the current sample value by receiving a value (e.g., a value of higher 8 bits from among the total 11 bits) of one or more bits of the previously obtained sample value, rather than the previously obtained sample value.

The AR network 141 according to an embodiment of the disclosure may include various types of pre-trained AI models in order to obtain a plurality of pieces of the feature information in the sample unit from the feature information in the frame unit and the previously obtained sample value. For example, the AR network 141 may include at least one gated recurrent unit (GRU) or at least one causal CNN layer, which corresponds to an RNN configured to use an output value in a previous operation as an input value in a current operation.

By performing a bunching operation, the bunching block group 142 according to an embodiment of the disclosure may obtain at least one sample value based on the feature information in the sample unit that is output by the AR network 141. The bunching block group 142 according to an embodiment of the disclosure may include one or more bunching blocks, and each of the bunching blocks may perform a sample bunching operation configured to obtain a sample value corresponding thereto.

The bunching block group 142 according to an embodiment of the disclosure may include bunching blocks, the number of which corresponds to the number of sample values that are obtained via a sample bunching operation based on the feature information in the sample unit with respect to one sample. For example, when sample values a1, a2, and a3 are obtained via the sample bunching operation based on feature information with respect to a sample a1, the bunching block group 142 performing the sample bunching operation based on the feature information with respect to the sample a1 may include three bunching blocks. Thereafter, whenever the sample bunching operation is performed based on the feature information with respect to another sample, the bunching block group 142 may be reconfigured to include the bunching blocks, the number of which corresponds to the number of obtained sample values.

Each bunching block included in the bunching block group 142 according to an embodiment of the disclosure may include at least one output layer (not shown).

The output layer according to an embodiment of the disclosure may output the sample value based on the feature information in the sample unit from the AR network 141. The output layer according to an embodiment of the disclosure may output the sample value one by one according to the feature information in the sample unit, by using a pre-trained AI model, such as a dual-fully connected (FC) layer, a softmax layer, a sampling layer, or the like.

The dual-FC layer and the softmax layer according to an embodiment of the disclosure may output probability information with respect to each sample value. For example, the dual-FC layer and the softmax layer may output the probability information with respect to sample candidate values of each sample value. The softmax layer according to an embodiment of the disclosure may be a layer used as a final layer of an AI model and may output probability information with respect to a value which may be output by the AI model. In addition, the probability information with respect to each sample value may be output based on various types of neural network layers (e.g., the FC layer), rather than the softmax layer.

The probability information according to an embodiment of the disclosure may include a probability distribution, which is a distribution indicating a probability in which a sample value may have each corresponding sample candidate value. The probability information is not limited to the example described above. The probability information may include various types of information indicating the probability in which a sample value may have each sample candidate value.

The softmax layer according to an embodiment of the disclosure may output a parameter configured to predict a probability distribution function (PDF) or a cumulative distribution function (CDF). Alternatively, the softmax layer may output, for example, a parameter configured to predict a Gaussian distribution, a logistic distribution, or a mixture distribution (e.g., a Gaussian mixture model (GMM) or a mixture of logistics (MoL)), rather than the PDF or the CDF. For example, the probability information of the Gaussian distribution may include an average and a standard deviation value as a parameter, rather than the probability distribution. In addition, the probability information of the logistic distribution may include an average and a scale parameter as a parameter. In addition, the probability information in which various types of probability distributions are synthesized may include a parameter configured to predict the synthesized probability distribution. The disclosure is not limited thereto. The softmax layer may output various types of probability information with respect to a sample value. A sampling layer according to an embodiment of the disclosure may output a sample value based on the probability information obtained with respect to each sample. For example, according to the softmax layer, a CDF may be generated based on a PDF with respect to each sample value, and a sample value corresponding to a probability value selected according to the CDF may be selected. The sampling layer is not limited to the example described above. The sampling layer may output the sample value based on the probability information that is output from the softmax layer.

For example, when a sample value is quantized according to the μ-law and may be indicated by the number of 8 bits, and when the sample value may be determined as one of 256 values corresponding to 2 raised to the power of 8, the probability information with respect to each of 256 sample candidate values may be determined by the softmax layer, and one sample value from among the 256 sample candidate values may be ultimately determined by the sampling layer.

The electronic device 1000 according to an embodiment of the disclosure may obtain at least one sample value based on feature information with respect to one sample by using at least one bunching block including at least one output layer, rather than obtaining one sample value based on feature information with respect to one sample by using one output layer. Thus, a speech signal may be quickly obtained by using a less amount of operations.

The bunching block group 142 according to an embodiment of the disclosure may perform the sample bunching operation configured to obtain one or more sample values, the number of which corresponds to the number of bunching blocks included in the bunching block group 142, based on the feature information with respect to one sample. Thus, the AR network 141 according to an embodiment of the disclosure may obtain feature information with respect to only one or more samples from among samples included in a frame, rather than obtaining feature information with respect to all of the samples included in the frame, based on feature information with respect to the frame.

In addition, according to an embodiment of the disclosure, the number of times in which an operation of obtaining the feature information with respect to a sample is performed by the AR network 141 may be decreased, to correspond to the number of bunching blocks included in the bunching block group 142. Thus, the amount of operations for generating the speech signal according to an embodiment may be decreased. For example, because N sample values may be obtained based on one piece of the feature information in the sample unit, through the sample bunching operation, the amount of operations of the AR network 141 may be reduced to 1/N.

Each bunching block according to an embodiment of the disclosure may obtain a current sample value based on the feature information with respect to a sample that is output by the AR network 141, and at least one sample value that is previously obtained based on the feature information with respect to the sample.

For example, the current sample value may be obtained based on vector information including a value obtained by converting the previously obtained sample value into a vector format, and vector information indicating the feature of the sample that is output from the AR network 141. The previously obtained sample value may be converted into the vector format according to a look-up table or an embedding layer. As another example, the current sample value may be obtained based on a result of a concatenating operation in which the at least one sample value is concatenated with the feature information with respect to the sample that is output from the AR network 141.

The disclosure is not limited thereto. The at least one sample value and the feature information with respect to one sample that is output from the AR network 141 may be converted into various formats and used to obtain the current sample value.

However, a sample value that is initially obtained based on the feature information with respect to one sample does not have a sample value that is previously obtained based on the same feature information with respect to the sample. Thus, the sample value may be obtained based on the feature information with respect to the sample, without the previously obtained sample value.

The sample bunching operation according to an embodiment of the disclosure may be performed by an AI model configured to obtain a sample value from the feature information with respect to the sample. For example, the sample bunching operation may be performed by a pre-trained AI model, such as a dual-FC layer, a softmax layer, and a sampling layer that are included in the output layer described above. The AI model used for the sample bunching operation, according to an embodiment of the disclosure, may be a model that is pre-trained to obtain an appropriate sample value based on feature information of a sample and at least one sample value previously obtained based on the same feature information of the sample. The disclosure is not limited thereto. The sample bunching operation according to an embodiment may be performed based on various methods of obtaining the sample value from the feature information of the sample.

According to an embodiment of the disclosure, the AR network 141 may determine with respect to which sample, the AR network 141 is to obtain the feature information, according to the sample bunching operation performed by the bunching block group 142. According to an embodiment of the disclosure, via the sample bunching operation, the bunching block group 142 may obtain a plurality of sample values from the feature information of one sample, and thus, in a current operation, the AR network 141 may determine with respect to which sample, the feature information is to be determined in a next operation, based on the sample values obtained via the sample bunching operation. For example, after the bunching block group 142 completes the sample bunching operation in the current operation, the AR network 141 may obtain the feature information with respect to next order sample values with respect to the obtained sample values. The disclosure is not limited to the example described above. It may be determined with respect to which sample, the feature information is to be obtained, based on parameter information used to form a bunching block, or other various information, to be described below.

According to a bit bunching operation according to an embodiment of the disclosure, each bunching block may perform an operation of obtaining a sample value from feature information of a sample, based on each group including a plurality of bits indicating one sample value.

The bunching block according to an embodiment may divide the plurality of bits (e.g., 8 bits) indicating one sample value into the plurality of groups, and for each group, an output layer may perform an operation of obtaining the sample value from the feature information of the sample, in order to obtain the plurality of bits indicating the sample value. For example, from among the bits included in one sample value, an operation of a first output layer with respect to bits of a first group and an operation of a second output layer with respect to bits of a second group may be performed. In addition, an output value of the first output layer may be combined with an output value of the second output layer to obtain one sample value.

For example, when a sample value may be indicated by the number of 8 bits and the number of higher 7 bits and the number of lower 1 bit are divided into the first group and the second group, respectively, the number of higher 7 bits may be determined as one of 128 sample candidate values corresponding to 2 raised to the power of 7, and the number of lower 1 bit may be determined as one of two sample candidate values corresponding to 2 raised to the power of 1. Thus, with the operations of the output layers with respect to the first group and the second group, probability information with respect to the 128 sample candidate values and probability information with respect to the 2 sample candidate values, respectively, may be determined. In addition, the output layer with respect to the first group may output the number, in which one sample value from among the 128 sample candidate values is indicated by 7 bits according to the probability information. In addition, the output layer with respect to the second group may output the number, in which one sample value of the 2 sample candidate values is indicated by 1 bit according to the probability information.

Thus, when the operations of the output layers are separately performed according to each of the plurality of groups, probability information with respect to the total 130 sample candidate values, which are the sum of 128 and 2, may be determined. However, when the operations of the output layers are not separately performed according to each of the plurality of groups and the sample value is obtained by one output layer, the probability information with respect to the 256 sample candidate values may be determined as described above. Accordingly, when the operations are separately performed according to each of the plurality of groups according to an embodiment of the disclosure, the amount of operations in the operation of obtaining the sample value may be reduced.

In addition, according to an embodiment of the disclosure, higher bits from among bits included in a sample value may affect more the sound quality of a speech signal than lower bits. Thus, according to an embodiment of the disclosure, the operation of the output layer with respect to a higher bit group from among the plurality of groups may be performed earlier than the operation of the output layer with respect to a lower bit group, and then, the operation of the output layer with respect to the lower bit group may be performed based on a higher bit by taking into account the consistency of a sample value.

According to an embodiment of the disclosure, information about the higher bit may be converted into a vector format according to a look-up table, an embedding layer, or the like, and may be used for the operation of the output layer with respect to the lower bit group. In addition, the operation of the output layer with respect to the lower bit group may be performed by using a concatenation operation in which the value converted into the vector format is concatenated with the feature information with respect to a sample that is output from the AR network 141. The disclosure is not limited thereto. The operation of the output layer with respect to the lower bit group may be performed based on the higher bit according to various methods.

The sample value according to an embodiment of the disclosure may be ultimately obtained as a combination of the bits of each of the groups. For example, with respect to a sample value of 8 bits, the number of 7 bits obtained by the bunching operation of the first group may be allocated to the position of the higher 7 bits of the 8 bits, and the number of 1 bit obtained by the bunching operation of the second group may be allocated to the position of the lower 1 bit of the 8 bits, so that the sample value of the 8 bits may be ultimately obtained.

The bunching block group 142 according to an embodiment of the disclosure may simultaneously perform the sample bunching operation and the bit bunching operation. For example, N sample values may be obtained via the sample bunching operation whenever the feature information with respect to one sample is obtained from the AR network 141. In addition, whenever each of the N sample values is obtained, the bit bunching operation may be performed for obtaining a bit value with respect to each of M groups into which bits included in the sample value are divided. Thus, the bunching block group 142 configured to obtain the sample value may include the bunching blocks including N*M output layers.

The parameter determiner 143 according to an embodiment of the disclosure may determine at least one parameter configured for the bunching block group 142 to perform at least one bunching operation. The parameter according to an embodiment of the disclosure may be determined as a value, via which the amount of operations of the SRN 140 and the sound quality of the speech signal may be optimally determined, based on information about a condition under which each bunching operation is performed.

In the bunching operation according to an embodiment of the disclosure, as the number of sample values obtained from the feature information with respect to one sample is increased, for example, as the number of bunching blocks included in the bunching block group 142 is increased, the number of pieces of feature information with respect to samples obtained by the AR network 141 is decreased. Thus, the amount of operations may be reduced. However, the sound quality of the speech signal may be degraded.

In addition, in the bunching operation according to an embodiment of the disclosure, higher bits of the sample value may affect more the sound quality of the speech signal than lower bits, and as the number of bits included in a group including the higher bits is decreased, the amount of operations may be reduced. In other words, when the number of bits included in the group including the higher bits is greater than the number of bits included in a group including the lower bits, the amount of operations may be increased, but the sound quality of the speech signal may be improved.

In addition, in the bunching operation according to an embodiment of the disclosure, as the number of total bits used to indicate one sample value is increased, the number of sample candidate values obtained with respect to the probability information may be increased. Thus, the amount of operations may be increased, but the sound quality may be improved.

Thus, the parameter according to an embodiment of the disclosure may be a value to affect the amount of operations in the bunching operation and the sound quality. The parameter may include the value for determining: the number of sample values obtained by a bunching operation from the feature information with respect to one sample; the number of total bits of the sample value; the number of groups, in each of which bits of the sample value are included; and the number of bits included in each group (e.g., a bit depth).

The parameter according to an embodiment of the disclosure may be determined according to the information about the condition, under which the bunching operation is performed. The condition information for determining the parameter according to an embodiment of the disclosure may include at least one of performance information of the electronic device 1000, performance information of a device (e.g., a speaker) configured to output a speech signal, information about a feature of a section (e.g., a frame section) in which a sample value is included, information about a feature of each sample value, or predetermined information in relation to a bunching operation.

The performance information of the electronic device 1000 and the performance information of the device configured to output the speech signal from among the condition information for the parameter according to an embodiment of the disclosure may include information that is not changed while the neural vocoder 120 operates. Thus, after device-based parameter information is determined based on the performance information of the electronic device 1000 and the performance information of the device configured to output the speech signal, frame-based parameter information or sample-based parameter information may be determined whenever the section (e.g., a section in a frame unit) in which each sample value is included is changed or a sample value is obtained. According to an embodiment of the disclosure, the frame-based parameter information or the sample-based parameter information may be determined based on the device-based parameter information which is determined earlier based on the performance information of the electronic device 1000 and the performance information of the device configured to output the speech signal.

The parameter information according to an embodiment of the disclosure may be determined by a pre-trained AI model based on the condition information, such that a parameter via which an appropriate sample value may be obtained through the bunching operation may be used. The disclosure is not limited thereto. The parameter information may be determined according to various methods, in addition to the method using the pre-trained AI model.

The device-based parameter information may be determined based on information about a device related to a generated speech signal according to an embodiment. The device information according to an embodiment of the disclosure may include at least one of the performance information of the electronic device 1000 configured to generate the speech signal or the performance information of the device (e.g., a speaker) configured to output the speech signal. The device information according to an embodiment of the disclosure is not limited to the example described above. The device information may include information related to various types of devices related to a generated speech signal, according to an embodiment.

According to an embodiment of the disclosure, the device-based parameter information may be determined according to the performance information of the electronic device 1000, such that the bunching operation of the neural vocoder 120 may be performed by using an appropriate amount of operations. According to an embodiment of the disclosure, the device-based parameter information may be determined according to the performance information of the electronic device 1000, such that the bunching operation of the neural vocoder 120 may be performed by using the amount of operations so as to be performed within a predetermined time period (e.g., 0.5 seconds).

According to an embodiment of the disclosure, the device-based parameter information may be determined according to the performance information of the device configured to output the speech signal, such that the speech signal of an appropriate sound quality may be obtained via the bunching operation of the neural vocoder 120. For example, the device-based parameter information may be determined according to the performance information of a speaker configured to output the speech signal, such that the speech signal appropriate for the level of sound quality that may be supported by the speaker may be obtained via the bunching operation of the neural vocoder 120.

The device-based parameter information according to an embodiment of the disclosure may be determined based on the obtained device information, before an operation of generating the speech signal corresponding to a text is started. For example, before starting the operation of generating the speech signal, the electronic device 1000 may obtain the performance information of the electronic device 1000 configured to perform the operation, and the performance information of the speaker configured to output the speech signal. Then, the electronic device 1000 may determine the device-based parameter information and then may perform the operation of generating the speech signal based on the device-based parameter information. The disclosure is not limited thereto. The device-based parameter information may be determined based on the device information obtained at various time points.

Furthermore, according to an embodiment of the disclosure, the frame-based parameter information may be determined according to a feature (e.g., a mute sound, a voiceless sound, a voiced sound, a volume of energy, or the like) of the speech signal of a section (e.g., a section in a frame unit) in which the bunching operation is performed, such that the speech signal having an appropriate sound quality may be obtained. For example, when the section in which the bunching operation is performed is a mute section or a voiceless sound section, a degree of possibility in which a listener may experience a change in the sound quality of the speech signal may be low. Thus, the frame-based parameter information may be determined such that the speech signal having a relatively low sound quality may be obtained. However, when the section in which the bunching operation is performed is a voiced sound section, a degree of possibility in which a listener may experience a change in the sound quality of the speech signal may be high. Thus, the frame-based parameter information may be determined such that the speech signal having a relatively high sound quality may be obtained.

The frame-based parameter information according to an embodiment of the disclosure may be determined, whenever the feature information of the speech signal in the frame unit is obtained from the acoustic model 110. The disclosure is not limited thereto. The frame-based parameter information may be determined based on various information about the speech signal in the frame unit that is obtained at various time points, according to various methods.

According to an embodiment of the disclosure, the sample-based parameter information may be determined according to a feature (e.g., a phoneme transference section or accuracy of prediction of a sample value) of each sample value, such that the speech signal having an appropriate sound quality may be obtained. According to an embodiment of the disclosure, the sample-based parameter information may be determined, by determining feature information with respect to a sample value that is to be currently obtained based on a feature of at least one previously obtained sample value, from which the sample value that is to be currently obtained may be predicted.

For example, when a sample that is to be currently obtained is determined to be included in the phoneme transference section, based on the one or more previously obtained sample values, there is as high possibility of a change between the sample values. Thus, the sample-based parameter information may be determined such that the number of sample values obtained based on feature information of one sample is relatively decreased. In addition, when an accuracy of each sample value determined according to probability information is low, based on a distribution shape of probability values of the probability information used to obtain the one or more previously obtained sample values in the bunching operation, an accuracy of the current sample value may also be determined to be low. Thus, by taking into account the accuracy expected with respect to the current sample value, the sample-based parameter information may be determined such that the sample value having a high accuracy, that is, the sample value of having a high sound quality, may be obtained.

The sample-based parameter information according to an embodiment of the disclosure may be determined whenever the sample value is obtained by the SRN 140. The disclosure is not limited thereto. The sample-based parameter information may be determined based on various information about sample values obtained at various time points, according to various methods.

The sample-based parameter information according to an embodiment of the disclosure may be determined based on at least one of the frame-based parameter information or the device-based parameter information, previously determined.

According to an embodiment of the disclosure, the bunching operation for obtaining each sample value may be performed based on the sample-based parameter information. However, the bunching operation is not limited thereto and may be performed based on at least one of the frame-based parameter information or the device-based parameter information. In addition, the bunching operation for obtaining each sample value may be performed according to predetermined parameter information, before the operation of generating the speech signal is started.

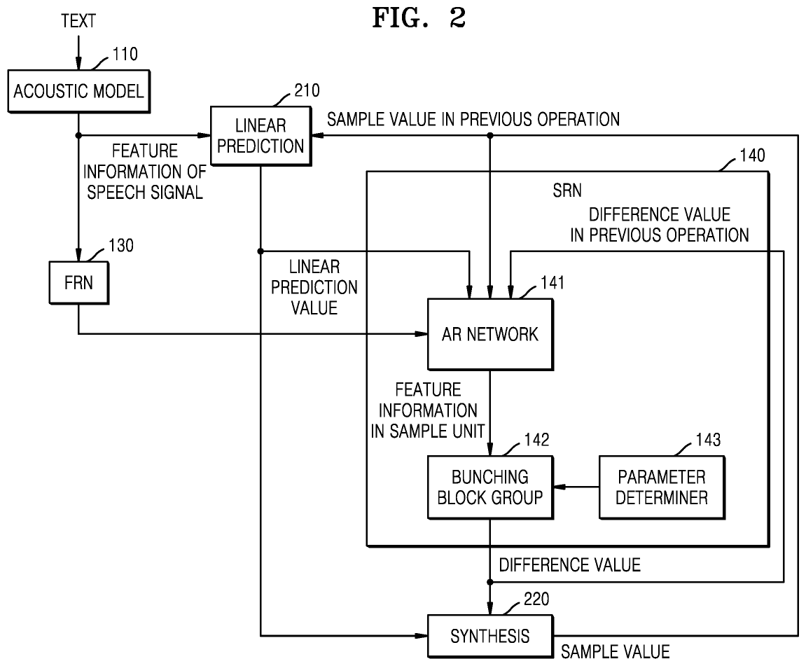

FIG. 2 is a block diagram illustrating a speech signal corresponding to a text being obtained based on a linear prediction value according to an embodiment of the disclosure.

Feature information in a sample unit that is output by the AR network 141 according to an embodiment may include feature information about a difference value (e.g., an excitation value) based on a value that is predicted via linear prediction with respect to a sample value. According to an embodiment of the disclosure, the sample value may be obtained by combining the linear prediction value and the difference value. Thus, when the SRN 140 according to an embodiment of the disclosure uses the linear prediction value with respect to the sample value, the AR network 141 may receive, as an input, in addition to the feature information in the frame unit obtained from the FRN 130 and the at least one sample value obtained in a previous operation, at least one difference value which is based on the linear prediction value with respect to a current sample value and at least one linear prediction value obtained in the previous operation.

According to an embodiment of the disclosure, operations of the AR network 141 and the bunching block group 142 of the SRN 140 may be performed with respect to the difference value which is based on the linearly predicted sample value, rather than the sample value. Thus, according to an embodiment of the disclosure, feature information and probability information may be obtained, with respect to the difference value with respect to the sample value, the difference value having a less value and a less change range than the sample value, rather than with respect to the sample value. Thus, the amount of operations or an error rate may further be reduced.

The disclosure is not limited thereto. The operation of the SRN 140 may be performed to obtain the feature information about the sample and the sample value, based on values obtained according to various methods for replacing the sample value.

In addition, the operation of the SRN 140 according to an embodiment of the disclosure may be performed based on quantized values of the sample value, the prediction value of the sample value, or the difference value of the sample value. For example, when a difference value between a sample value and another sample value is indicated by the number of 16 bits indicating one of −32768 to 32767 values, the sample value, the prediction value of the sample value, or the difference value of the prediction value may be quantized as the number of 8 bits according to the 8 bit u-law quantization method, and then, a quantization index, which is the quantized value, may be used by the SRN 140, rather than the sample value. According to an embodiment of the disclosure, index values corresponding to ranges in which values are included may be assigned, to quantize the sample value, the prediction value, and the difference value. Based on the quantized value according to an embodiment of the disclosure, the number of values that are processed are greatly reduced, and thus, the amount of operations may be reduced.

Thus, in this specification, although the operation of the SRN 140 according to an embodiment of the disclosure is described, for convenience of descriptions, as the operation of obtaining the sample value, the operation of the SRN 140 may also include an operation performed based on a value replacing the sample value (e.g., the difference value with respect to the linear prediction value (e.g., an excitation value), and the quantized value).

Unlike FIG. 1, referring to FIG. 2, a linear prediction 210 and a synthesis 220, related to the linear prediction operation, may further be performed.

In addition, configurations of the acoustic model 110, the FRN 130, the SRN 140, the AR network 141, the bunching block group 142, and the parameter determiner 143 of FIG. 2 may correspond to configurations of the acoustic model 110, the FRN 130, the SRN 140, the AR network 141, the bunching block group 142, and the parameter determiner 143 of FIG. 1.

In the linear prediction 210 according to an embodiment of the disclosure, a linear prediction value with respect to a sample value to be obtained by the SRN 140 in a current operation may be obtained, based on sample values obtained in a previous operation and feature information of a speech signal obtained from the acoustic model 110,

In the linear prediction operation 210 according to an embodiment of the disclosure, the electronic device 1000 may obtain the linear prediction value with respect to the current sample value by predicting the current sample value via a linear function of the sample values obtained in the previous operation. The electronic device 1000 according to an embodiment of the disclosure may obtain a linear prediction value with respect to a sample value, the linear prediction value being not incompatible with feature information of a speech signal, by further taking into account the feature information of the speech signal.

According to an embodiment of the disclosure, the operation of the SRN 140 may be performed by using the linear prediction value. According to an embodiment of the disclosure, the operation of the SRN 140 may be performed based on a difference value between the linear prediction value and the sample value, rather than based on the sample value. The difference value according to an embodiment of the disclosure may have a smaller value and a less change range than the sample value, and thus, when the difference value is used rather than the sample value, the operation of the SRN 140 may have a reduced amount of operations or a reduced error rate.

According to an embodiment of the disclosure, the linear prediction value that is input from the linear prediction 210 to the AR network 141 may be quantized by the number of 8 bits according to the 8 bit u-law quantization method, and then, may be input to the AR network 141. In this case, the difference value obtained in a previous operation, which is input to the AR network 141, may be a value that is output from the SRN 140 in a quantized state, and thus, the difference value may be input to the AR network 141 without conversion. In addition, the sample value obtained in a previous operation, which is input to the AR network 141, may be a value that is inverse-quantized in the synthesis 220 for a synthesis with the linear prediction value, and thus, the sample value may be quantized by the number of 8 bits according to the 8 bit u-law quantization method, and then, may be input to the AR network 141.

The electronic device 1000 according to an embodiment of the disclosure may reduce the number of values processed by the SRN 140 including the AR network 141, by using the quantized values. Thus, the amount of operations may be reduced. The disclosure is not limited thereto. The linear prediction value may be variously changed so that the SRN 140 including the AR network 141 may optimally operate.

The AR network 141 according to an embodiment of the disclosure may output feature information about at least one sample included in a frame, based on feature information about the frame obtained from the FRN 130. The feature information in a sample unit that is output from the AR network 141 according to an embodiment of the disclosure may be feature information about a difference value eₜ between a sample value sₜ and a linear prediction value pₜ, rather than about the sample value. Thus, the AR network 141 according to an embodiment of the disclosure may output the feature information about the difference value eₜ as feature information about a current sample, by further taking into account the linear prediction value pₜ with respect to the current sample, in addition to the feature information in the frame unit of the FRN 130.

In addition, the AR network 141 according to an embodiment of the disclosure may obtain the feature information about the current sample further based on at least one of sample values sₜ₋₁, sₜ₋₂, . . . obtained in a previous operation, difference values eₜ₋₁, eₜ₋₂, . . . corresponding to the sample values, or linear prediction values pₜ₋₁, pₜ₋₂, . . . , in addition to the feature information in the frame unit of the FRN 130. At least two of the sample values sₜ₋₁, sₜ₋₂, . . . obtained in the previous operation, the difference values eₜ₋₁, eₜ₋₂, . . . corresponding to the sample values, and the linear prediction values pₜ₋₁, pₜ₋₂, . . . may be concatenated and input to the AR network 141 to be used in obtaining the feature information about the current sample.

Based on the feature information about the current sample, the bunching block group 142 according to an embodiment of the disclosure may output at least one sample value corresponding to the feature information. Because the feature information about the current sample that is output from the AR network 141 includes the feature information about the difference value eₜ rather than the sample value sₜ, the bunching block group 142 according to an embodiment of the disclosure may output the difference value eₜ rather than the sample value sₜ. According to a sample bunching operation according to an embodiment of the disclosure, when a plurality of sample values are obtained from the feature information about one sample, a plurality of difference values eₜ, eₜ₊₁, eₜ₊₂, . . . may be output from the bunching block group 142 based on feature information about one difference value eₜ.

Because at least one difference value eₜ, eₜ₊₁, eₜ₊₂, . . . or e_{t+B-1} output from the bunching block group 142 and the linear prediction value may be synthesized in the synthesis 220 according to an embodiment of the disclosure, at least one sample value sₜ, sₜ₊₁, sₜ₊₂, . . . , or s_{t+B-1} including the current sample may be obtained. Here, “B” may indicate the number of bunching blocks included in the bunching block group 142, the bunching block each performing the bunching operation.

According to an embodiment of the disclosure, when the SRN 140 uses quantized values, a difference value output from the SRN 140 may be a quantized value. Thus, according to an embodiment of the disclosure, in order to synthesize the difference value output from the SRN 140 and the linear prediction value in the synthesis 220, the difference value may be inverse-quantized, and then, may be synthesized with the linear prediction value.

According to a sample bunching operation according to an embodiment of the disclosure, when difference values about a plurality of samples are obtained based on the feature information about one sample, linear prediction values pₜ₊₁, pₜ₊₂, . . . , and p_{t+B-1} corresponding to the difference values eₜ₊₁, eₜ₊₂, . . . , and e_{t+B-1}, respectively, may further be obtained in the linear prediction 210, in addition to the linear prediction value pₜ that is input to the AR network 141. For example, the linear prediction 210 may further obtain the linear prediction values pₜ₊₁, pₜ₊₂, . . . , and p_{t+B-1} corresponding to the difference values eₜ₊₁, eₜ₊₂, . . . , and e_{t+B-1} based on the previously obtained sample values and the feature information of the speech signal.

According to an embodiment of the disclosure, the synthesis 220 may obtain the sample values sₜ, sₜ₊₁, sₜ₊₂, . . . , and s_{t+B-1} by simply combining the difference values eₜ, eₜ₊₁, eₜ₊₂, . . . , and e_{t+B-1} with the linear prediction values pₜ, pₜ₊₁, pₜ₊₂, . . . , and p_{t+B-1}.

According to an embodiment of the disclosure, at least one of the obtained sample values sₜ, sₜ₊₁, sₜ₊₂, . . . , and s_{t+B-1} may be input to the AR network 141 in a next operation and used to obtain feature information about a next sample s_{(t+B-1)+1}. In addition, the sample values are not limited thereto. At least one of the obtained difference values eₜ, eₜ₊₁, eₜ₊₂, . . . , and e_{t+B-1} according to an embodiment may be input to the AR network 141 in a next operation and used to obtain the feature information about the next sample S_{(t+B-1)+1}. When the AR network 141 according to an embodiment of the disclosure outputs the feature information about the difference values with respect to the linear prediction value, rather than about the sample values, the difference values may be input to the AR network 141 so that the feature information about the sample may be output, not only based on the sample values in a previous operation, but also based on the difference values in the previous operation.

At least one of the sample values Sₜ, Sₜ₊₁, Sₜ₊₂, . . . , and S_{t+B-1} according to an embodiment of the disclosure may be used by the linear prediction 210 to obtain linear prediction values P_{(t+B-1)+1}, P_{(t+B-1)+2}, . . . , with respect to next samples S_{(t+B-1)+1}, S_{(t+B-1)+2}, . . . .

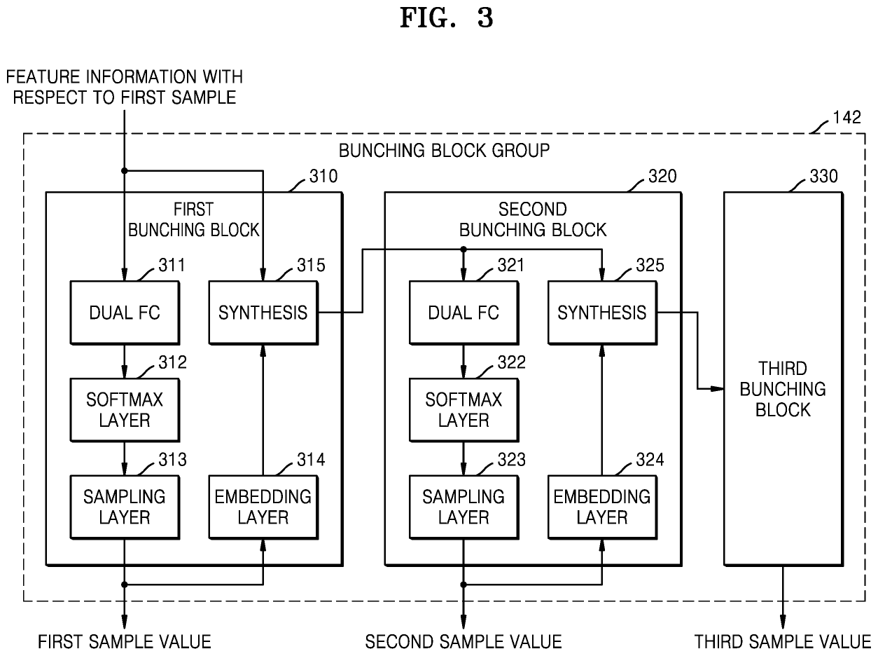

FIG. 3 is a block diagram illustrating a bunching block group according to an embodiment of the disclosure.

Referring to FIG. 3, the bunching block group 142 according to an embodiment of the disclosure may output first through third sample values based on feature information about a first sample that is output from the AR network 141. The bunching block group 142 according to an embodiment of the disclosure may include at least one bunching block and may output at least one sample value via each bunching block. For example, a first bunching block, a second bunching block, and a third bunching block may output the first through third sample values, respectively, based on the feature information about the first sample.

Each bunching block according to an embodiment of the disclosure may include a dual FC 311 or 321, a softmax layer 312 or 322, and a sampling layer 313 or 323, which are included in an output layer configured to output the sample value based on the feature information about the sample. The bunching block is not limited thereto. Each bunching block may include various components configured to output the sample value based on the feature information about the sample.

According to an embodiment of the disclosure, a configuration of an embedding layer 314 and a synthesis 353 of the first bunching block 310 may process the first sample value and the feature information about the first sample so that the second bunching block 320 may obtain the second sample value based on the first sample value and the feature information about the first sample. According to an embodiment of the disclosure, the first sample value may be converted into a vector format by the embedding layer 314 and then may be combined with the feature information about the first sample in the synthesis 315, so as to be transmitted to the second bunching block 320. The disclosure is not limited thereto. The first sample value and the feature information about the first sample may be processed by using various methods and then may be transmitted to the second bunching block 320.

The second bunching block 320 according to an embodiment of the disclosure may obtain the second sample value based on the first sample value and the feature information about the first sample received from the first bunching block 310. According to an embodiment of the disclosure, a configuration of an embedding layer 324 and a synthesis 325 of the second bunching block 320 may process the second sample value, the first sample value, and the feature information about the first sample so that the third bunching block 330 may obtain the third sample value based on the second sample value, the first sample value, and the feature information about the first sample. The disclosure is not limited thereto. The second sample value, the first sample value, and the feature information about the first sample according to an embodiment of the disclosure may be processed according to various methods and then may be transmitted to the third bunching block 330.

Thus, each bunching block according to an embodiment of the disclosure may output a current sample value based on at least one of at least one previously obtained sample value in the same bunching block group 142 or feature information about one sample used in the same bunching block group 142.

According to an embodiment of the disclosure, a plurality of sample values may be obtained by the bunching block group 142 based on the feature information about one sample, and thus, the number of pieces of the feature information about the sample obtained by the AR network 141 may be reduced, and thus, the amount of operations may be reduced.

When the operation of each of the bunching blocks 310, 320, and 330 is performed based on the difference value with respect to the linear prediction value, rather than the sample value, each of the bunching blocks 310, 320, and 330 may output the difference value with respect to the sample value, based on the feature information about the difference value with respect to the sample value, rather than the sample value. The disclosure is not limited thereto. Each bunching block 310, 320, or 330 may operate based on various values configured to replace the sample values.

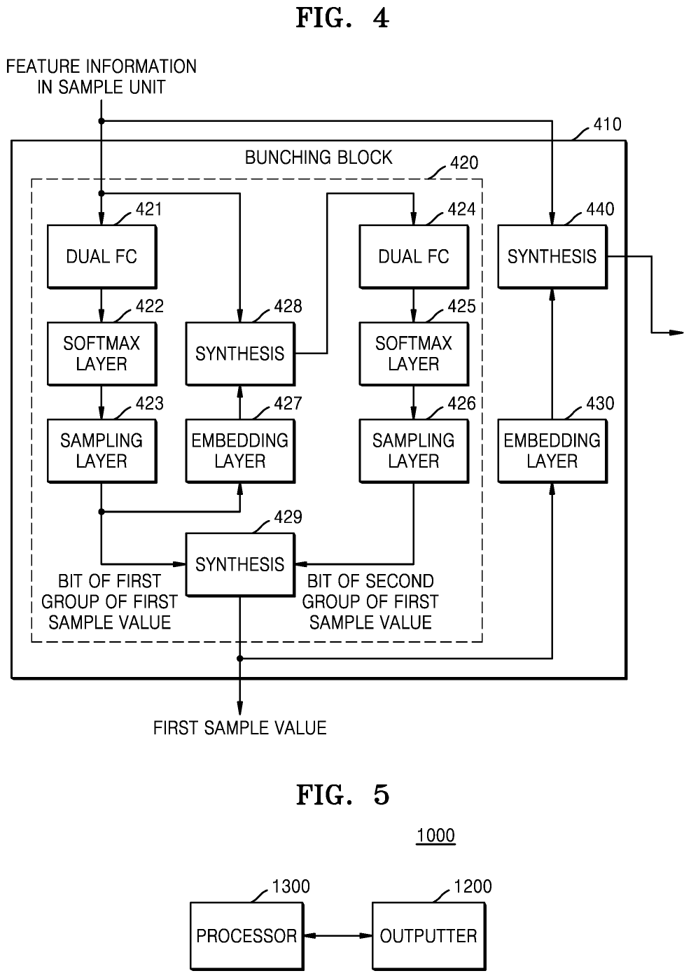

FIG. 4 is a block diagram illustrating a bunching block according to an embodiment of the disclosure.

Referring to FIG. 4, at least one of the bunching blocks included in a bunching block group 142 according to an embodiment may be configured as a bunching block 410 illustrated in FIG. 4.

The bunching block 410 illustrated in FIG. 4 may include each of the dual FC 311, the softmax layer 312, and the sampling layer 313 included in the output layer of the bunching blocks 310, 320, and 330 of FIG. 3, in a multiple number, as shown in the indication 420.

The bunching block 410 according to an embodiment of the disclosure may include a plurality of output layers so that the bunching operation may be performed for each group including a plurality of bits indicating sample values, for the bit bunching operation.

According to the bit bunching operation according to an embodiment of the disclosure, the bits of the sample values may be obtained by the output layers, respectively, for each divided group.

According to an embodiment of the disclosure, the output layer is not limited to the configuration illustrated in FIG. 4. The sample value may be obtained via the bit bunching operation based on various configurations for obtaining the sample value from the feature information about the sample.

According to an embodiment of the disclosure, based on feature information in a sample unit that is input to the bunching block 410, a dual FC 421, a softmax layer 422, and a sampling layer 423 that are included in an output layer of a first group may obtain a value of a bit included in the first group from among values included in the first sample value. The value of the bit included in the first group may be processed via a configuration of an embedding layer 427 and a synthesis 428, and then, may be input to an output layer of a second group. Thus, a value of a bit of the second group may be obtained based on the value of the bit of the first group.

In addition, according to an embodiment of the disclosure, based on the feature information in the sample unit that is input to the bunching block 410, a dual FC 424, a softmax layer 425, and a sampling layer 426 that are included in the output layer of the second group may obtain a value of a bit included in the second group from among the values included in the first sample value. The feature information in the sample unit that is input to the bunching block 410 according to an embodiment of the disclosure may be synthesized with the value of the bit of the first group by the synthesis 428, in order to take into account the value of the bit included in the first group to obtain the value of the bit of the second group.

According to an embodiment of the disclosure, a synthesis 429 may obtain the first sample value by synthesizing the value of the bit of the first group with the value of the bit of the second group.

An embedding layer 430 and a synthesis 440 according to an embodiment of the disclosure may correspond to the embedding layers 314 and 324 and the syntheses 315 and 325 illustrated in FIG. 3 and may process and output a current sample value so that the current sample value may be taken into account for a next bunching operation.

FIG. 5 is a block diagram illustrating an inner structure of an electronic device according to an embodiment of the disclosure.

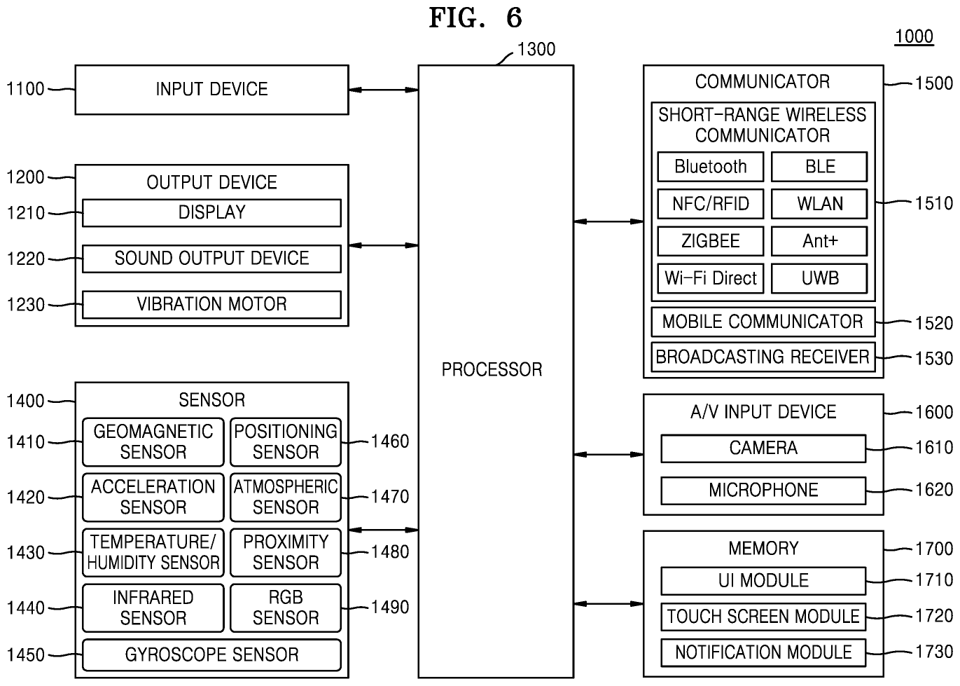

FIG. 6 is a block diagram illustrating an inner structure of an electronic device according to an embodiment of the disclosure.

Referring to FIG. 5, the electronic device 1000 may include a processor 1300 and an output device 1020. However, not all of the components illustrated in FIG. 5 are essential components of the electronic device 1000. The electronic device 1000 may be implemented by including more or fewer components than the components illustrated in FIG. 5.

For example, as illustrated referring to FIG. 6, the electronic device 1000 according to an embodiment of the disclosure may further include a user input device 1100, a sensor 1400, a communicator 1500, an audio/video (A/V) input device 1600, and a memory 1700, in addition to the processor 1300 and the output device 1020.

The user input device 1100 may denote a device via which a user may input data for controlling the electronic device 1000. For example, the user input device 1100 may include a key pad, a dome switch, a touch pad (a touch capacitance method, a pressure resistive-layer method, an infrared detection method, a surface ultrasonic conduction method, an integral tension measurement method, a piezo effect method, or the like), a jog wheel, a jog switch, or the like, but is not limited thereto.

According to an embodiment of the disclosure, the user input device 1100 may receive a user input for generating a speech signal corresponding to a text. For example, in order to respond to the user input, a speech signal corresponding to the response may be generated.

The output device 1200 may output an audio signal, a video signal, or a vibration signal. In addition, the output device 1200 may include a display 1210, a sound output device 1220, and a vibration motor 1230.

The display 1210 may display and output information processed in the electronic device 1000. According to an embodiment of the disclosure, the display 1210 may display a guide message including information about detected messenger fishing or voice fishing.

When the display 1210 forms a layered structure with a touch pad to be implemented as a touch screen, the display 1210 may be used as both an output device and an input device. The display 1210 may include at least one of a liquid crystal display, a thin-film transistor-liquid crystal display, an organic light-emitting diode, a flexible display, a three-dimensional (3D) display, or an electrophoretic display. According to a form in which the electronic device 1000 is implemented, the electronic device 1000 may include at least two displays 1210.

The display 1210 according to an embodiment of the disclosure may output information about a result in which a speech signal corresponding to a text is generated.

The sound output device 1220 may output audio data received from the communicator 1500 or stored in the memory 1700.

The sound output device 1220 according to an embodiment of the disclosure may output the generated speech signal corresponding to the text.

The vibration motor 1230 may output a vibration signal. In addition, the vibration motor 1230 may output the vibration signal when a touch is input in the touch screen. According to an embodiment of the disclosure, the vibration motor 1230 may output information about a result in which a speech signal corresponding to a text is generated.

In general, the processor 1300 may control general operations of the electronic device 1000. For example, the processor 1300 may execute programs stored in the memory 1700 to generally control the user input device 1100, the output device 1200, the sensor 1400, the communicator 1500, the A/V input device 1600, or the like.

The electronic device 1000 may include at least one processor 1300. For example, the electronic device 1000 may include various types of processors, such as a central processing unit (CPU), a graphics processing unit (GPU), a neural processing unit (NPU), or the like.

The processor 1300 may be configured to perform basic arithmetic operations, logic and input and output operations, thereby processing commands of the computer programs. The commands may be provided to the processor 1300 from the memory 1700 or may be received by the communicator 1500 and provided to the processor 1300 by the communicator 1500. For example, the processor 1300 may be configured to execute the commands according to program codes stored in a recording device, such as the memory.

The processor 1300 according to an embodiment of the disclosure may be configured to obtain feature information about a first sample included in the speech signal based on at least one text and to obtain at least one sample value included in the speech signal based on the feature information. In addition, the processor 1300 may be configured to obtain information about a condition under which a bunching operation is performed for obtaining the at least one sample value from the feature information and to form at least one bunching block configured to perform the bunching operation, based on the information about the condition. In addition, the processor 1300 may be configured to use the bunching block to obtain the at least one sample value, in order to generate the speech signal corresponding to the text.

The bunching block according to an embodiment of the disclosure may be configured such that the bunching operation may be performed for each of a plurality of groups into which bits included in the sample value are divided. For example, the bits included in the sample values may be divided based on the information about the condition, and the bunching block including a plurality of output layers corresponding to the plurality of groups, respectively, may be configured. According to an embodiment of the disclosure, output values for each of the plurality of groups may be combined in one bunching block, and thus, one sample value may be obtained.

The bunching block for obtaining the sample value according to an embodiment may be configured based on parameter information corresponding to the sample value. For example, each bunching block may be configured based on sample-based parameter information with respect to the sample value corresponding to each bunching block. The parameter information according to an embodiment of the disclosure may be determined based on various information about the condition in which the sample value is obtained, such that a speech signal having an appropriate amount of operations and an appropriate sound quality may be obtained. For example, the parameter information may include information about the number of sample values obtained based on feature information about one sample according to a sample bunching operation, the number of bits indicating the sample values, the number of bits included in each of the plurality of groups, or the like.

The sensor 1400 may detect a state of the electronic device 1000 or a state around the electronic device 1000 and transmit the detected information to the processor 1300.

The sensor 1400 may further include at least one of a geomagnetic sensor 1410, an acceleration sensor 1420, a temperature/humidity sensor 1430, an infrared sensor 1440, a gyroscope sensor 1450, a positioning sensor (for example, a global positioning system (GPS)) 1460, an atmospheric sensor 1470, a proximity sensor 1480, or a red, green, and blue (RGB) sensor (an illuminance sensor) 1490, but is not limited thereto.

The communicator 1500 may include one or more components for allowing the electronic device 1000 to communicate with a server 2000 or an external device (not shown). For example, the communicator 1500 may include a short-range wireless communicator 1510, a mobile communicator 1520, and a broadcasting receiver 1530.

The short-range wireless communicator 1510 may include a Bluetooth communicator, a Bluetooth low energy (BLE) communicator, a near-field communicator, a wireless local area network (WLAN) (Wi-Fi) communicator, a Zigbee communicator, an infrared data association (IrDA) communicator, a Wi-Fi direct (WFD) communicator, an ultra-wideband (UWB) communicator, an Ant+ communicator, or the like, but is not limited thereto.

The mobile communicator 1520 may transceive wireless signals with at least one of a base station, an external terminal, or a server, through a mobile communication network. Here, the wireless signals may include a sound call signal, a video-telephony call signal, or various forms of data according to transmission and reception of text/multimedia.

The broadcasting receiver 1530 may receive broadcasting signals and/or broadcasting-related information from the outside through broadcasting channels. The broadcasting channel may include a satellite channel, a ground wave channel, or the like. According to an embodiment of the disclosure, the electronic device 1000 may not include the broadcasting receiver 1530.

The communicator 1500 according to an embodiment may transmit and receive data required to generate the speech signal corresponding to the text.

The A/V input device 1600 may be configured to input an audio signal or a video signal and may include a camera 1610 and a microphone 1620. The camera 1610 may obtain an image frame, such as a still image or a video, through an image sensor in a video telephony mode or a capturing mode. An image captured by the image sensor may be processed by the processor 1300 or an additional image processor (not shown).

The microphone 1620 may receive an external sound signal and process the sound signal into electrical sound data. For example, the microphone 1620 may be used to receive a voice input of a user for generating the speech signal corresponding to the text.

The memory 1700 may store a program for processing and controlling operations of the processor 1300 and may store data input to the electronic device 1000 or output from the electronic device 1000.

The memory 1700 according to an embodiment may store data required to generate the speech signal corresponding to the text. For example, the memory 1700 may store the information about the condition in which each sample of the speech signal is obtained and the parameter information which may be determined based on the information about the condition. According to the information about the condition according to an embodiment of the disclosure, the parameter information for configuring the bunching block may be determined. Thus, the speech signal having an appropriate amount of operations and an appropriate sound quality may be generated. In addition, the memory 1700 may store the generated speech signal corresponding to the text, according to an embodiment of the disclosure.

The memory 1700 may include at least one type of storage medium from a flash memory-type storage medium, a hard disk-type storage medium, a multimedia card micro-type storage medium, a card-type memory (for example, secure digital (SD) or extreme digital (XD) memory), random access memory (RAM), static RAM (SRAM), read only memory (ROM), electrically erasable programmable ROM (EEPROM), programmable ROM (PROM), a magnetic memory, a magnetic disk, or an optical disk.

The programs stored in the memory 1700 may be divided into a plurality of modules according to functions. For example, the programs may be divided into a user interface (UI) module 1710, a touch screen module 1720, a notification module 1730, or the like.

The UI module 1710 may provide a specialized UI, a specialized graphical user interface (GUI), or the like, which are synchronized with the electronic device 1000 according to an application. The touch screen module 1720 may detect a touch gesture of a user on the touch screen and transmit information about the touch gesture to the processor 1300. The touch screen module 1720 according to an embodiment of the disclosure may recognize and analyze a touch code. The touch screen module 1720 may be formed as an additional hardware device including a controller.

Various sensors may be provided in or around the touch screen to detect a touch or an approximate touch on the touch screen. For example, a haptic sensor may be provided as an example of the sensor for detecting the touch on the touch screen. The tactile sensor refers to a sensor configured to detect a touch of a specific object as a human being detects or better than a human being. The tactile sensor may detect various information, such as the roughness of a contact surface, the rigidity of a contact object, and the temperature of a contact point.

The user's touch gestures may include tap, touch & hold, double tap, drag, panning, flick, drag and drop, swipe, and the like.

The notification module 1730 may generate a signal for notifying about an occurrence of an event of the electronic device 1000.

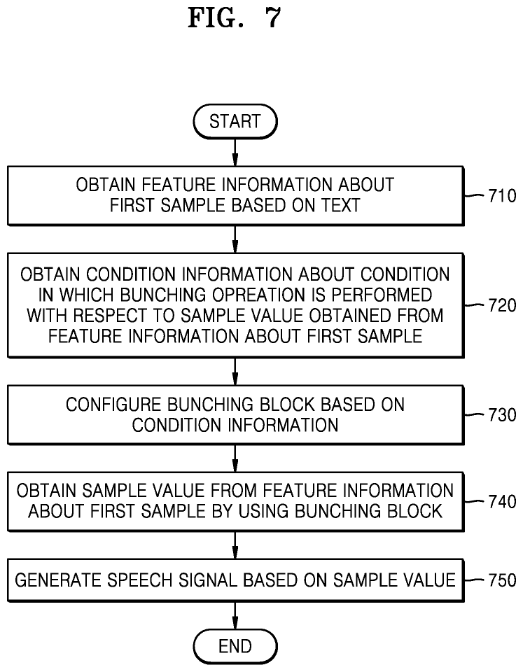

FIG. 7 is a flowchart of a method of generating a speech signal corresponding to a text according to an embodiment of the disclosure.

Referring to FIG. 7, in operation 710, the electronic device 1000 according to an embodiment of the disclosure may obtain feature information about a first sample from among one or more samples included in a speech signal, based on at least one text.

The feature information about the first sample according to an embodiment of the disclosure may be obtained from feature information about a frame including the first sample, from among pieces of feature information about one or more frames corresponding to the text. In addition, the feature information about the first sample may be obtained by at least one AI model that is pre-trained to obtain the feature information about the first sample from the text. The disclosure is not limited to the example described above. The feature information about the first sample according to an embodiment of the disclosure may be obtained according to various methods.

In operation 720, the electronic device 1000 may obtain information about a condition related to a bunching operation, which is to be performed hereinafter. The bunching operation according to an embodiment of the disclosure may include obtaining one or more samples included in the speech signal based on the feature information about the first sample obtained in operation 710.

The bunching operation according to an embodiment of the disclosure may include a sample bunching operation configured to obtain a plurality of sample values based on the feature information about one sample and a bit bunching operation configured to obtain the sample values by obtaining bits indicating the sample values for each of a plurality of groups.

Based on the sample bunching operation and the bit bunching operation according to an embodiment of the disclosure, the amount of operations may be reduced. However, a speech signal having a relatively decreased sound quality may be obtained. For example, as the number of sample values obtained based on the feature information about one sample is increased, according to the sample bunching operation, the amount of operations may be decreased, but the speech signal having a decreased sound quality may be obtained. In addition, as the number of bits of a group including higher bits is increased, according to the bit bunching operation, the amount of operations may be increased, but the speech signal having an increased sound quality may be obtained.

Thus, according to an embodiment of the disclosure, based on whether or not a speech signal having a high sound quality needs to be output, at least one of the sample bunching operation or the bit bunching operation, configured to obtain the sample value, may be performed. For example, when a section of the speech signal, in which the sample value is included, corresponds to a mute section or a section having a low variability, or when the performance of a speaker through which the speech signal is output is relatively low, it may not be required to output the speech signal having a high sound quality. In addition, when the performance of the electronic device 1000 configured to generate the speech signal is relatively low, the less amount of operations may be more required than the speech signal having a high sound quality.

According to an embodiment of the disclosure, the bunching operation may be performed to obtain the sample value, based on information about a condition in which the sample value is obtained. The information about the condition according to an embodiment of the disclosure may include, for example, performance information of the electronic device 1000 configured to generate a speech signal, performance information of a speaker configured to output a speech signal, information about a level of sound quality of a section in which a sample value is included (e.g., a mute section, a level of variability, or the like), or the like. In addition, the information about the condition according to an embodiment of the disclosure may further include information that is predetermined by a user, with respect to the bunching operation.

The information about the condition according to an embodiment of the disclosure is not limited to the example described above and may include various types of information for determining the bunching operation configured to obtain a speech signal having an appropriate amount of operations and an appropriate sound quality.

In operation 730, the electronic device 1000 according to an embodiment of the disclosure may configure a bunching block configured to perform the bunching operation, based on the information about the condition obtained in operation 720. The bunching block according to an embodiment of the disclosure may include at least one output layer and may be configured to perform the bunching operation configured to obtain the sample value.

According to an embodiment of the disclosure, the number of sample values obtained based on the feature information about the first sample may be determined based on the information about the condition, and thus, the bunching block configured to perform the sample bunching operation, the number of which corresponds to the number of sample values, may be generated. For example, when it is determined to generate three sample values based on the feature information about the first sample, three bunching blocks for outputting the corresponding sample values, respectively, may be generated.

In addition, according to an embodiment of the disclosure, based on the information about the condition, bits of the sample value generated by each bunching block may be divided into a plurality of groups for the bit bunching operation. The bunching block according to an embodiment of the disclosure may include output layers, the number of which corresponds to the number of the groups, and the output layers may obtain bit values of the groups corresponding thereto, respectively.

For example, based on the information about the condition, the total number of bits indicating the sample value may be determined as 8, and the bits of the sample value may be divided into two groups including a higher bit group and a lower bit group. In addition, based on the information about the condition, the bunching block may be configured such that 7 higher bit values may be output in the higher bit group and 1 lower bit value may be output in the lower bit group. For example, according to the bunching block configured based on the information about the condition, a first output layer corresponding to the higher bit group may output the 7 higher bit values, and a second output layer corresponding to the lower bit group may output the 1 lower bit value. The disclosure is not limited to the example described above. Each bunching block may be variously configured based on the information about the condition to perform the bunching operation for obtaining the sample value.

In operation 740, the electronic device 1000 according to an embodiment of the disclosure may obtain at least one sample value from the feature information about the first sample, by using the bunching block configured in operation 730.

According to an embodiment of the disclosure, whenever the sample value is obtained, the bunching block configured to obtain each sample value may be generated based on the information about the condition. Thus, according to an embodiment of the disclosure, the bunching operation using an optimal amount of operations may be performed according to the information about the condition corresponding to the sample value, to obtain the sample value.

According to an embodiment of the disclosure, sample-based parameter information with respect to each sample value may be determined based on the information about the condition of each sample value, and the bunching block may be configured based on the determined sample-based parameter information.

In addition, according to an embodiment of the disclosure, a first sample value may be obtained based on the feature information about the first sample. However, with respect to another sample value after the first sample value, it may be determined, based on the parameter information with respect to each sample value, whether or not each sample value is to be obtained based on the feature information about the first sample. For example, when a value indicating the number of sample values that are obtained via a bunching operation from feature information about a second sample from among the parameter information about a second sample value is 0, the bunching block with respect to the second sample value may be configured such that the second sample value may be obtained based on the feature information about the first sample.

Each bunching block according to an embodiment of the disclosure may include at least one output layer and may output the sample value, based on the parameter information about the bit bunching operation According to an embodiment of the disclosure, a plurality of bits indicating the sample value may be divided based on the parameter information and the bunching block including the output layer, the number of which corresponds to the number of the divided groups, may be configured.

One or more sample values obtained by at least one bunching block based on the feature information about the first sample according to an embodiment of the disclosure may be sequentially obtained based on previously obtained sample values. For example, any one of the one or more sample values may be obtained based on at least one previously obtained sample value from among the one or more sample values and the feature information about the first sample.

In operation 750, the electronic device 1000 according to an embodiment of the disclosure may generate a speech signal, based on the sample value obtained in operation 740. According to an embodiment of the disclosure, the speech signal may be generated by arranging the sample values to be sequentially output through a speaker. The disclosure is not limited thereto. The speech signal may be generated in various forms according to various methods, based on the sample value.

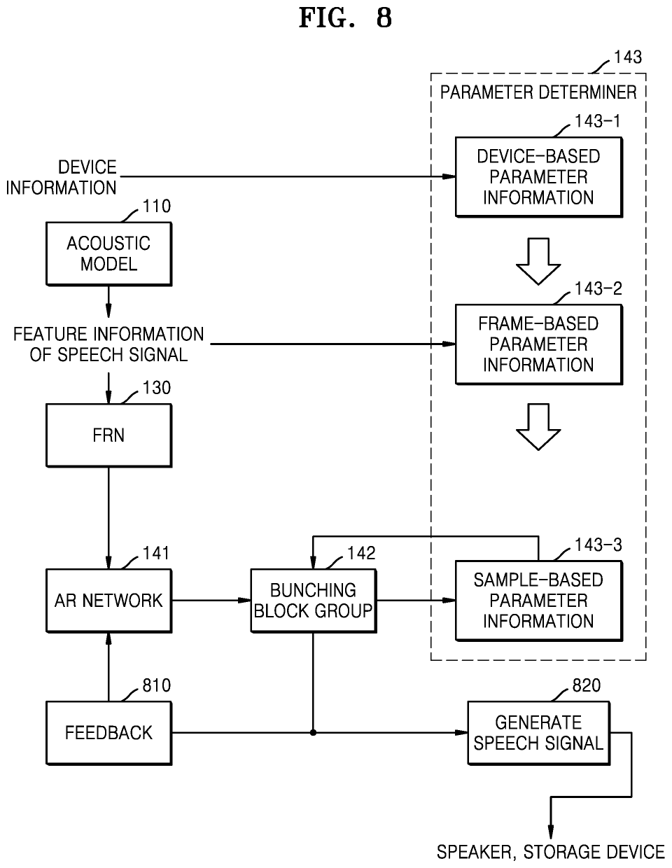

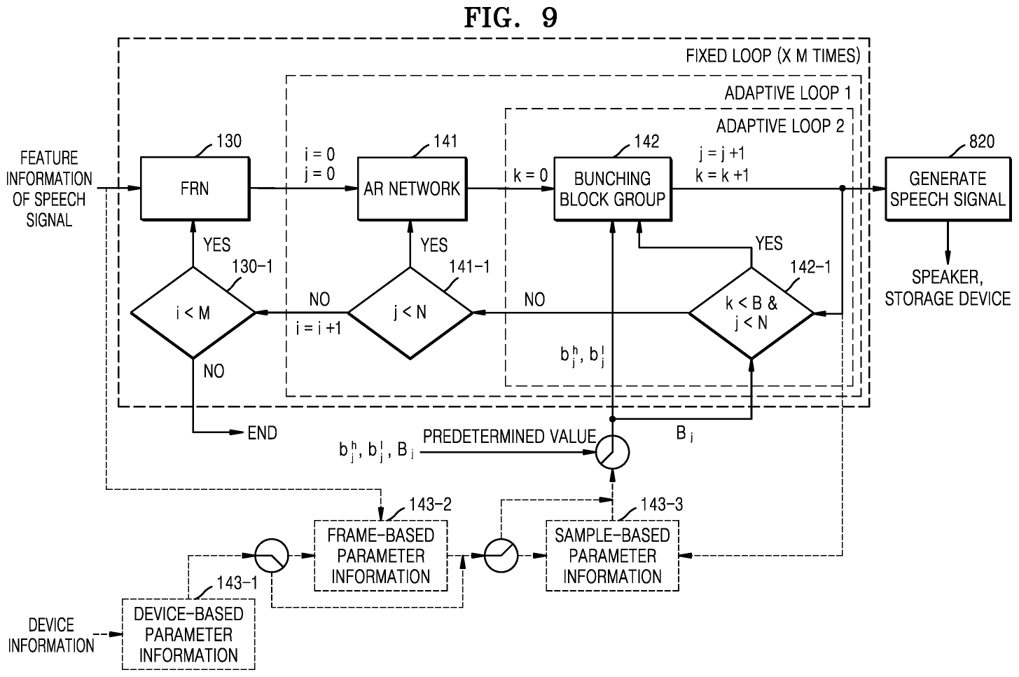

FIG. 8 is a block diagram illustrating parameter information being determined according to an embodiment of the disclosure.

Referring to FIG. 8, the acoustic model 110, the FRN 130, the SRN 140, the AR network 141, the bunching block group 142, and the parameter determiner 143 of FIG. 8 may correspond to the acoustic model 110, the FRN 130, the SRN 140, the AR network 141, the bunching block group 142, and the parameter determiner 143 of FIG. 1.

The parameter determiner 143 according to an embodiment of the disclosure may determine device-based parameter information 143-1, frame-based parameter information 143-2, and sample-based parameter information 143-3.

The parameter information according to an embodiment of the disclosure may include information about a parameter related to the bunching operation performed by the bunching block group 142 to obtain the sample value. For example, the parameter information may include values determining: the number B of sample values obtained through a bunching operation from the feature information about one sample; the total number b of bits of the sample value; the number of groups each including the bits of the sample value; and the number b^{h} or b^{l} of the bits included in each group. The parameter information is not limited thereto and may include various types of parameter values related to the bunching operation.

The device-based parameter information 143-1, the frame-based parameter information 143-2, and the sample-based parameter information 143-3, determined according to an embodiment of the disclosure, may include values determined with respect to the same parameter. For example, the device-based parameter information 143-1, the frame-based parameter information 143-2, and the sample-based parameter information 143-3 may include the information determined with respect to the values B, b, b^{h}, and b^{l} described above.

According to an embodiment of the disclosure, after the device-based parameter information 143-1 is determined, the frame-based parameter information 143-2 may be determined, and then, the sample-based parameter information 143-3 may be determined based on the frame-based parameter information 143-2. The bunching operation performed by the bunching block group 142 to obtain the sample value according to an embodiment of the disclosure may be performed based on the sample-based parameter information 143-3 that is finally determined.

The parameter information according to an embodiment of the disclosure may be determined according to the information about the condition. The information about the condition according to an embodiment of the disclosure may include information about a condition in which the sample value is obtained by the bunching block group 142. For example, the information about the condition may include information about a device related to a speech signal, feature information in a frame unit corresponding to the speech signal, and feature information in a sample unit corresponding to the speech signal.

The device-based parameter information 143-1 according to an embodiment of the disclosure may be obtained based on the information about the device related to the speech signal from among the information about the condition. For example, the information about the condition may include performance information of the electronic device 1000 configured to generate the speech signal, performance information of a speaker configured to output the speech signal, or the like.

The device-based parameter information 143-1 according to an embodiment of the disclosure may be determined based on the performance information of the electronic device 1000 configured to generate the speech signal, such that an appropriate length of time may be required to generate the speech signal by the electronic device 1000. For example, as the performance of the electronic device 1000 is low, the value B may be determined to be relatively great, so that the number of samples obtained based on the feature information of one sample may be increased. In addition, the value B may be determined to be relatively small so that the number of bits indicating the sample value may be decreased. In addition, the value b^{h} or b^{l} indicating the number of bits included in each group may be determined, such that the number of sample candidate values predicted in each group may be decreased.

In addition, the device-based parameter information 143-1 according to an embodiment of the disclosure may be determined based on the performance information of the speaker configured to output the speech signal, from among the information about the condition, such that the speech signal having a sound quality appropriate for the performance of the speaker may be generated. According to an embodiment of the disclosure, even when the speech signal having a high sound quality is generated, when the performance of the speaker is low, the speech signal having a low sound quality may be output. Thus, the device-based parameter information 143-1 may be determined such that the speech signal having a sound quality appropriate for the performance of the speaker may be generated. For example, as the performance of the speaker is low, the value B may be determined to be relatively great, so that the number of samples obtained based on the feature information about one sample may be increased. In addition, the value B may be determined to be relatively small so that the number of bits indicating the sample value may be decreased. In addition, the value b^{h} or b^{l} indicating the number of bits included in each group may be determined, such that the number of sample candidate values predicted in each group may be decreased.

The device-based parameter information 143-1 is not limited thereto and may be determined according to various methods and various information such that the speech signal having a sound quality appropriate for the performance of a device related to the speech signal may be generated.

The device information according to an embodiment of the disclosure may information that may be pre-obtained before the operation of generating the speech signal is performed, and thus, the device-based parameter information 143-1 may be predetermined before the operation of generating the speech signal is performed.

The frame-based parameter information 143-2 according to an embodiment of the disclosure may be determined based on feature information in a frame unit of the speech signal from among the information about the condition. The feature information in the frame unit according to an embodiment of the disclosure may be feature information of the speech signal that may be obtained by the acoustic model 110. According to an embodiment of the disclosure, whenever the feature information of the speech signal is obtained in the frame unit by the acoustic model 110, the frame-based parameter information 143-2 may be determined. The frame-based parameter information 143-2 is not limited to the example described above and may be determined based on the feature information of the speech signal in the frame unit obtained according to various methods.

The feature information of the speech signal in the frame unit according to an embodiment of the disclosure may include, for example, information about a feature of the speech signal, such as a mute sound, a voiceless sound, a voiced sound, a volume of energy, or the like. According to an embodiment of the disclosure, the frame-based parameter information 143-2 may be determined according to the feature of the speech signal, such that the speech signal having an appropriate sound quality may be generated by considering a degree in which a listener may experience a change in the sound quality of the speech signal.

When the speech signal according to an embodiment of the disclosure has the feature of a mute sound or a voiceless sound or the feature of a low volume of energy, even when the speech signal having a high sound quality is output, it may be difficult for a listener to experience the speech signal having the high sound quality, and thus, the frame-based parameter information 143-2 may be determined such that the speech signal having a relatively low sound quality may be obtained. For example, as a section of the speech signal corresponds to a section in which the speech signal has the feature of the mute sound or the voiceless sound, the value B may be determined to be relatively great, so that the number of samples obtained based on the feature information of one sample may be increased. In addition, the value B may be determined to be relatively small so that the number of bits indicating the sample value may be decreased. In addition, the value b^{h} or b^{l} indicating the number of bits included in each group may be determined, such that the number of sample candidate values predicted in each group may be decreased.

When the speech signal according to an embodiment of the disclosure has the feature of a voiced sound or a high volume of energy, as a sound quality of the speech signal is increased, it may become easy for the listener to experience the speech signal having a high sound quality, and thus, the frame-based parameter information 143-2 may be determined such that the speech signal having a relatively high sound quality may be obtained. For example, as a section of the speech signal corresponds to a section in which the speech signal has the feature of the voiced sound or the high volume of energy, the value B may be determined to be relatively small, so that the number of samples obtained based on the feature information of one sample may be decreased. In addition, the value B may be determined to be relatively great so that the number of bits indicating the sample value may be increased. In addition, the value b^{h} or b^{l} indicating the number of bits included in each group may be determined such that the value b^{h} may be greater than the value b^{l} so that the number of bits of a group including higher bits may be increased.

The frame-based parameter information 143-2 is not limited thereto and may be determined according to various methods and various information such that the speech signal having a sound quality appropriate for the feature of the speech signal may be generated.

The frame-based parameter information 143-2 according to an embodiment of the disclosure may be determined based on the parameter value of the device-based parameter information 143-1 which is determined earlier than the frame-based parameter information 143-2. For example, while the value B may be corrected based on the feature information in the frame unit, the value B may be corrected not to be determined as a value that is excessive compared with the performance of the speaker. The frame-based parameter information 143-2 is not limited thereto and may be determined based on the device-based parameter information 143-1 according to various methods.

The sample-based parameter information 143-3 according to an embodiment of the disclosure may be determined based on at least one of feature information of the sample value of the speech signal from among the information about the condition, or predetermined information. The feature information of the sample value according to an embodiment of the disclosure may be determined according to the sample value obtained by the bunching block group 142 through the bunching operation. According to an embodiment of the disclosure, the sample-based parameter information 143-3 may be determined with respect to a sample that is to be obtained in a current operation based on at least one sample value previously obtained by the bunching block group 142 in a previous operation. The sample-based parameter information 143-3 is not limited to the example described above and may be determined based on the feature information of the speech signal in the frame unit that is obtained according to various methods.

The feature information of the sample value according to an embodiment of the disclosure may include information about a feature about each sample value, such as a phoneme transference section, an accuracy of prediction of a sample value, or the like. According to an embodiment of the disclosure, the sample-based parameter information 143-3 may be determined according to the feature of the sample value, such that the speech signal having an appropriate sound quality may be generated.

When the sample values in previous operations according to an embodiment of the disclosure correspond to a phoneme transference section, there is a high variability between the sample values, and thus, the sound quality experienced by a listener may be greatly different according to a sound quality of the speech signal. Thus, the sample-based parameter information 143-3 may be determined such that the speech signal having a relatively high sound quality may be obtained. For example, as the sample values in the previous operations correspond to a section in which a degree of phoneme transference is increased, the value B may be determined to be relatively small, so that the number of samples obtained based on the feature information of one sample may be decreased. In addition, the value B may be determined to be relatively great so that the number of bits indicating the sample value may be increased. In addition, the value b^{h} or b^{l} indicating the number of bits included in each group may be determined such that the value b^{h} may be greater than the value b^{l} so that the number of bits of a group including higher bits may be increased.

As a prediction accuracy determined based on probability information with respect to the sample values in the previous operations is decreased, the sample-based parameter information 143-3 may be determined such that the speech signal having a relatively high sound quality may be obtained. For example, as the prediction accuracy of the sample values in the previous operations is decreased, the value B may be determined to be relatively small, so that the number of samples obtained based on the feature information of one sample may be decreased. In addition, the value B may be determined to be relatively great so that the number of bits indicating the sample value may be increased. In addition, the value b^{h} or b^{l} indicating the number of bits included in each group may be determined such that the value b^{h} may be greater than the value b^{l} so that the number of bits of a group including higher bits may be increased.

The sample-based parameter information 143-3 is not limited thereto and may be determined according to various methods and various information such that the speech signal having a sound quality appropriate for the feature of the speech signal may be generated.

According to an embodiment of the disclosure, the sample-based parameter information 143-3 may be obtained based on predetermined information. The predetermined information according to an embodiment may include a parameter value predetermined with respect to each sample. In addition, the predetermined information may include a parameter value predetermined by a user before the operation of generating the speech signal according to an embodiment of the disclosure is started.

The sample-based parameter information 143-3 according to an embodiment may be determined based on at least one of the parameter value of the device-based parameter information 143-1 that is previously determined, or the frame-based parameter information 143-2. For example, while the value B may be corrected based on the feature of the previously obtained sample value, the value B may be corrected not to be determined as a value that is excessive compared with the performance of the speaker or a value that is inappropriate for the feature of the frame. The sample-based parameter information 143-3 is not limited thereto and may be determined based on the device-based parameter information 143-1 and the frame-based parameter information 143-2 according to various methods.

The sample-based parameter information 143-3 according to an embodiment of the disclosure may be determined according to at least one previously obtained sample value and may be used by the bunching block group 142 to obtain the current sample through the sample bunching operation and the bit bunching operation.

For example, the bit bunching operation with respect to the current sample may be performed based on the values b, b^{h}, and b^{l} from among the sample-based parameter information 143-3. In addition, the sample bunching operation with respect to the current sample may be performed based on the value B from among the sample-based parameter information 143-3.

The values b, b^{h}, and b^{l} from among the sample-based parameter information 143-3 according to an embodiment of the disclosure may be determined for each sample value. The value B may also be determined for each sample value. However, the value B may be determined to be a value not incompatible with respect to the value B determined with respect to a previous sample. For example, when the value B determined with respect to a sample having an index k is 3, the value B with respect to a current sample having an index k+1 may be determined as 0, so that the current sample may be obtained based on feature information with respect to a value of the sample having the index k. Thereafter, from a sample having an index k+3, because the sample bunching operation may be performed based on feature information of a new sample, the value B of the sample having the index k+3 may be determined irrelevantly to the value B of the sample having the index k. The value B of the current sample having the index k+1 is not limited thereto and may be determined, based on the feature information of the current sample, irrelevantly to the value B determined with respect to the previous sample, such that a plurality of sample values may be obtained. In addition, the value B with respect to the current sample having the index k+1 may be determined based on the feature information of the current sample according to various methods.

According to an embodiment of the disclosure, the sample values obtained by the bunching block group 142 may be used to obtain the sample-based parameter information 143-3. However, the sample values may also be input to feedback 810 of the AR network 141. The feedback 810 according to an embodiment of the disclosure may correspond to an operation of receiving, via the AR network 141 of FIG. 1, sample values previously obtained by the bunching block group 142.

In addition, the speech signal may be generated in operation 820 based on the sample values obtained by the bunching block group 142 according to an embodiment and may be output through the speaker or stored in a memory of the electronic device 1000 or an external storage device (not shown).

FIG. 9 is a block diagram illustrating a bunching operation being performed based on parameter information according to an embodiment of the disclosure.

Referring to FIG. 9, the FRN 130, the AR network 141, and the bunching block group 142 of FIG. 9 may correspond to the FRN 130, the AR network 141, and the bunching block group 142 of FIG. 1. In addition, the device-based parameter information 143-1, the frame-based parameter information 143-2, the sample-based parameter information 143-3, and the operation 820 of generating the speech signal of FIG. 9 may correspond to the device-based parameter information 143-1, the frame-based parameter information 143-2, the sample-based parameter information 143-3, and the operation 820 of generating the speech signal of FIG. 8.

When the feature information of the speech signal with respect to M frames is obtained from the acoustic model 110 according to an embodiment of the disclosure, the FRN 130 may output M pieces of feature information in a frame unit with respect to frame 0 to frame M−1. Thus, when an index i indicating the frame is less than M (130-1), the operation of the FRN 130 may be repeatedly performed. The index i indicating the frame according to an embodiment of the disclosure may be increased from 0 by 1 whenever the feature information with respect to all of the samples included in one frame is obtained by the AR network 141, so that the FRN 130 may output the feature information with respect to a next frame.

The AR network 141 according to an embodiment of the disclosure may output feature information of a plurality of samples, with respect to the feature information of one frame unit. When N samples are included in one frame, the operation of the AR network 141 may be repeatedly performed with respect to a sample 141-1 having an index j, wherein a value j is smaller than N.

The operation of the AR network 141 according to an embodiment of the disclosure may be adaptively performed according to the value B of the sample-based parameter information 143-3. For example, as the value B is increased, the AR network 141 may output fewer pieces of the feature information with respect to the sample, in the same frame. Thus, the speech signal having a relatively low sound quality may be obtained.

The bunching block group 142 according to an embodiment of the disclosure may perform the operation of obtaining B sample values, based on the feature information with respect to one sample, according to the value B determined based on the sample-based parameter information 143-3. Thus, in 142-1, when a value k, which is counted from the samples of the feature information output by the AR network 141 is less than the value B and the value j of the index j indicating a sample is less than N, the operation performed by the bunching block group 142 to obtain the sample value may be repeatedly performed. The values k and j according to an embodiment of the disclosure may be increased by 1 whenever a sample value is obtained via a sample bunching operation based on the feature information with respect to one sample.

According to an embodiment of the disclosure, the operation of the bunching block group 142 may be adaptively performed according to the values B, b, b^{h}, and b^{l} of the sample-based parameter information 143-3. For example, the sample bunching operation may be performed by forming the bunching blocks, the number of which corresponds to the value B, and the bit bunching operation may be performed by adding, in each bunching block, a configuration for the bit bunching operation according to the values b, b^{h} and b^{l}.

The operation of the bunching block group 142 is not limited to the example described above. The operation of the bunching block group 142 may be performed according to a parameter value according to at least one of the device-based parameter information 143-1 or the frame-based parameter information 143-2, in addition to a parameter value according to the sample-based parameter information 143-3. For example, when the sample-based parameter information 143-3 has a lower accuracy than other parameter information 143-1 and 143-2 due to various factors, the bunching block group 142 may operate based on the other parameter information 143-1 and 143-2, rather than the sample-based parameter information 143-3.

The device-based parameter information 143-1 according to an embodiment of the disclosure may be determined based on previously obtained device information.

The frame-based parameter information 143-2 according to an embodiment of the disclosure may be determined based on the feature information of the speech signal with respect to a current frame. In addition, the frame-based parameter information 143-2 may be determined based on the device-based parameter information 143-1.

The sample-based parameter information 143-3 according to an embodiment of the disclosure may be determined based on previously obtained sample values. In addition, the sample-based parameter information 143-3 may be determined based on at least one of the device-based parameter information 143-1 or the frame-based parameter information 143-2.

The bunching block group 142 according to an embodiment of the disclosure may perform the bunching operation based on parameter values (e.g., Bⱼ, bⱼ, b^{h}ⱼ, and b^{l}ⱼ) predetermined with respect to a current sample j, rather than based on the sample-based parameter information 143-3, the device-based parameter information 143-1, and the frame-based parameter information 143-2. For example, the parameter values (e.g., Bⱼ, bⱼ, b^{h}ⱼ, and b^{l}ⱼ) predetermined with respect to the current sample j may be the sample-based parameter information 143-3 and may be used to perform each bunching operation of the bunching block group 142.

According to an embodiment of the disclosure, a speech signal corresponding to a text may be generated, whereby deterioration of the sound quality may be minimized and the amount of operations for generating the speech signal may be reduced.

A device-readable storage medium may include a form of a non-transitory storage medium. Here, the expression of “non-transitory storage medium” may only indicate that the medium is a tangible device, rather than a signal (for example, an electromagnetic wave), and does not distinguish a semi-permanent storage of data in the storage medium and a temporary storage of data in the storage medium. For example, the “non-transitory storage medium” may include a buffer in which data is temporarily stored.

According to an embodiment of the disclosure of the disclosure, methods according to various embodiments of the disclosure may be provided as a computer program product. The computer program product may be purchased as a product between a seller and a purchaser. The computer program product may be distributed in the form of a storage medium (for example, a compact disc read-only memory (CD-ROM)), or directly distributed online (e.g., download or upload) through an application store (e.g., Play Store™) or between two user devices (e.g., smartphones). In the case of online distribution, at least a portion of the computer program product (e.g., a downloadable app) may be at least temporarily stored or generated in a device-readable storage medium, such as a memory of a server of a manufacturer, a server of an application store, or a broadcasting server.

In addition, in this specification, a “unit” may refer to a hardware component, such as a processor or a circuit, and/or a software component executed by a hardware component, such as a processor.

While the disclosure has been particularly shown and described with reference to example embodiments thereof, it will be understood by one of ordinary skill in the art that various changes in form and details may be made therein without departing from the spirit and scope of the disclosure as defined by the following claims. Hence, it will be understood that the embodiments described above are examples in all aspects and are not limiting of the scope of the disclosure. For example, each of components described as a single unit may be executed in a distributed fashion, and likewise, components described as being distributed may be executed in a combined fashion.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by an electronic device, of generating a speech signal corresponding to at least one text, the method comprising:
obtaining feature information with respect to a first sample included in the speech signal, based on the at least one text;
obtaining condition information related to a condition under which a bunching operation, in which one or more sample values included in the speech signal are obtained, is performed, based on the feature information;
configuring one or more bunching blocks for performing the bunching operation, based on the condition information;
obtaining the one or more sample values based on the feature information with respect to the first sample by using the one or more bunching blocks; and
generating the speech signal, based on the obtained one or more sample values.

2. The method of claim 1, wherein the condition information comprises at least one of performance information of the electronic device, performance information of a device configured to output the speech signal, information about a feature of a section in which the one or more sample values are included, information about a feature of each of the one or more sample values, or information that is predetermined in relation to the bunching operation.

3. The method of claim 1,
wherein, based on the condition information, parameter information for configuring the one or more bunching blocks is determined, and
wherein the parameter information comprises at least one of a number of the one or more sample values that are to be obtained from the feature information of the first sample, a number of total bits of each of the one or more sample values, or a number of bits of each of a plurality of groups into which the total bits are divided.

4. The method of claim 3, wherein the obtaining of the one or more sample values comprises:
obtaining one or more pieces of parameter information respectively corresponding to the one or more sample values, based on the condition information with respect to the one or more sample values;
configuring the one or more bunching blocks respectively corresponding to the one or more sample values, based on the obtained one or more pieces of parameter information; and
obtaining the one or more sample values by using the configured one or more bunching blocks.

5. The method of claim 3,
wherein the parameter information comprises at least one of device-based parameter information, frame-based parameter information, or sample-based parameter information,
wherein the device-based parameter information is determined based on at least one of performance information of the electronic device or performance information of a device configured to output the speech signal,
wherein the frame-based parameter information is determined with respect to each of frames, based on information about a feature of a frame in which the one or more sample values are included, and
wherein the sample-based parameter information is determined with respect to each of the one or more sample values, based on at least one of information about a feature of each of the one or more sample values, or predetermined information.

6. The method of claim 5,
wherein the frame-based parameter information is determined based on the device-based parameter information that is determined earlier than the frame-based parameter information,
wherein the sample-based parameter information is determined based on at least one of the device-based parameter information or the frame-based parameter information that are determined earlier than the sample-based parameter information, and
wherein the one or more bunching blocks are configured based on at least one of the device-based parameter information, the frame-based parameter information, or the sample-based parameter information.

7. The method of claim 1,
wherein the configuring of the one or more bunching blocks comprises:
when the one or more sample values are indicated by a plurality of bits, dividing the plurality of bits into a plurality of groups based on the condition information, and
configuring the one or more bunching blocks respectively corresponding to the one or more sample values, the one or more bunching blocks including a plurality of output layers respectively corresponding to the plurality of groups, and
wherein the one or more sample values are obtained by combining bit values obtained from the plurality of groups including the plurality of bits.

8. An electronic device for generating a speech signal corresponding to at least one text, the electronic device comprising:
at least one processor configured to:
obtain feature information with respect to a first sample included in the speech signal, based on the at least one text,
obtain condition information related to a condition under which a bunching operation, in which one or more sample values included in the speech signal are obtained, is performed, based on the feature information,
configure one or more bunching blocks for performing the bunching operation, based on the condition information,
obtain the one or more sample values based on the feature information with respect to the first sample by using the one or more bunching blocks, and
generate the speech signal based on the obtained one or more sample values; and
an output device configured to output the speech signal.

9. The electronic device of claim 8, wherein the condition information comprises at least one of performance information of the electronic device, performance information of a device configured to output the speech signal, information about a feature of a section in which the one or more sample values are included, information about a feature of each of the one or more sample values, or information that is predetermined in relation to the bunching operation.

10. The electronic device of claim 8,
wherein, based on the condition information, parameter information for configuring the one or more bunching blocks is determined, and
wherein the parameter information comprises at least one of a number of the one or more sample values that are to be obtained from the feature information of the first sample, a number of total bits of each of the one or more sample values, or a number of bits of each of a plurality of groups into which the total bits are divided.

11. The electronic device of claim 10, wherein the at least one processor is further configured to:
obtain one or more pieces of parameter information respectively corresponding to the one or more sample values, based on the condition information with respect to the one or more sample values;
configure the one or more bunching blocks respectively corresponding to the one or more sample values, based on the obtained one or more pieces of parameter information; and
obtain the one or more sample values by using the configured one or more bunching blocks.

12. The electronic device of claim 10,
wherein the parameter information comprises device-based parameter information, frame-based parameter information, and sample-based parameter information,
wherein the device-based parameter information is determined based on at least one of performance information of the electronic device or performance information of a device configured to output the speech signal,
wherein the frame-based parameter information is determined with respect to each of frames, based on information about a feature of a frame in which the one or more sample values are included, and
wherein the sample-based parameter information is determined with respect to each of the one or more sample values, based on at least one of information about a feature of each of the one or more sample values, or predetermined information.

13. The electronic device of claim 12,
wherein the frame-based parameter information is determined based on the device-based parameter information that is determined earlier than the frame-based parameter information,
wherein the sample-based parameter information is determined based on at least one of the device-based parameter information or the frame-based parameter information that are determined earlier than the sample-based parameter information, and
wherein the one or more bunching blocks are configured based on at least one of the device-based parameter information, the frame-based parameter information, or the sample-based parameter information.

14. The electronic device of claim 8,
wherein the at least one processor is further configured to:
divide a plurality of bits into a plurality of groups based on the condition information, when the one or more sample values are indicated by the plurality of bits, and
configure the one or more bunching blocks respectively corresponding to the one or more sample values, the one or more bunching blocks including a plurality of output layers respectively corresponding to the plurality of groups, and
wherein the one or more sample values are obtained by combining bit values obtained from the plurality of groups including the plurality of bits.

15. The electronic device of claim 8, wherein the at least one processor is further configured to extract the feature information of the speech signal by taking into account the at least one text and style information of the speech signal.

16. The electronic device of claim 8, wherein the feature information of the speech signal comprises at least one of information about a pitch lag, information about a pitch correlation, or information about an aperiodicity.

17. At least one non-transitory computer-readable recording medium having recorded thereon a program for executing the method of claim 1 on a computer.
